(19) United States
(12) Patent Application Publication
(10) Pub. No.: US 2007/0112685 A1
(43) Pub. Date: May 17, 2007

(54) Contents distribution system, recording apparatus, signature apparatus, contents supply apparatus, and contents playback apparatus

(76) Inventor: Masato Yamamichi, OSAKA (JP)

Correspondence Address: WENDEROTH, LIND & PONACK L.L.P., 2033 K. STREET, NW, SUITE 800, WASHINGTON, DC, 20006, US

(21) Appl. No.: 10/557,148

(22) PCT Filed: Jun. 3, 2004
(86) PCT No.: PCT/JP04/08084

§ 371 Date: Jan. 2, 2007

(30) Foreign Application Priority Data
Jun. 4, 2003 (JP) 2003-159386

(51) Int. Cl. G06Q 30/00

(52) U.S. Cl. 705/64

(57) ABSTRACT

Second content relating to first content recorded on a portable recording medium is prevented from being illegally used. A contents supply apparatus outputs signature data and the second content to a playback apparatus, the signature data having been generated based on content information relating to at least one of the first and second content, with use of first key information. A distribution apparatus that distributes the first content outputs second key information corresponding to the first key information. The playback apparatus verifies the signature data with use of the second information, and plays back the second content when the verification is successful.

### TECHNICAL FIELD

The present invention relates to a technique for distributing digital contents.

### BACKGROUND ART

Recording media such as DVDs on which digital works such as movies and music are recorded are becoming widespread. Recording media such as DVDs have a large amount of information digitally recorded thereon, and therefore can be used semipermanently without deterioration.

A large market has been built by the evolution of businesses that use such recording media to sell and/or rent out recording media on which movies and music are recorded. Prevention of illegal use of digital works recorded on recording media is crucial for such businesses.

Document 1 discloses an electronic data protection system that aims to prevent illegal use of computer software, electronic publications and the like stored on recording media.

This electronic data protection system protects electronic data stored on a recording medium that is used in a user apparatus, based on usage permission from an apparatus held by a usage permitting party. The recording apparatus stores a medium unique number that uniquely specifies the encrypted electronic data and the recording medium. The usage permitting apparatus includes a decryption key for decrypting encrypted electronic data stored on the recording medium, a permission information generation unit that, based on the medium unique number stored on the recording medium, encrypts the electronic data decryption key and generates permission information, and a writing unit that writes the permission information generated by the permission information generation unit to the recording medium. The user apparatus includes a reading unit that reads the permission information, the encrypted electronic data and the medium unique number from the recording medium, a decryption key generation unit that, based on the medium unique number, decrypts the permission information and generates the electronic data decryption key, and an electronic data decryption unit that, based on the electronic data decryption key generated by the decryption key generation unit, decrypts the encrypted electronic data.

According to such a structure, an electronic data protection system can be obtained that enables the user apparatus to use only encrypted electronic data that is stored on a legal storage medium and whose usage has been permitted by the usage permitting apparatus.

Furthermore, Document 2 discloses the following technique.

A system, method and article of manufacture is provided for tracking the distribution of content electronically. First, an electronic storage medium tracking identifier is incorporated onto an electronic storage medium and stored on a database. Next, a package tracking identifier is situated onto a package in which the electronic storage medium is stored. The electronic storage medium is then tracked while being shipped between various entities using the tracking identifier on the package. Further, the electronic storage medium may be identified using the tracking identifier on the electronic storage medium in order to afford authorized use of the information contained on the electronic storage medium.

Since various techniques such as those described above have come to enable prevention of illegal usage of contents written to recording media, businesses that rent and/or sell such recording media are expanding.

Furthermore, Document 3 discloses the following technique for preventing PCM audio data recorded as part of content on a recording medium from being isolated from the content and played back.

Digital audio is recorded encrypted on the recording medium. Information necessary for decrypting the encrypted digital audio data is recorded in a program for controlling processing for playing the audio data, separately from the digital audio data.

This technique prevents the sub-content, which is linked to main content, from being isolated from the main content and played back.

Meanwhile, in recent times sub-content related to main content recorded on a recording medium is being distributed in forms that do not use recording media. An example of such sub-content is a preview of a movie that is the sequel to a movie recorded on a recording medium. This preview is distributed to users via the Internet or the like.

However, while the described prevention technique is able to prevent illegal use of content written to a recording medium, it is problematic in that it is unable to prevent illegal use of sub-content that relates to the main content on the recording medium and distributed by another distribution path.

Document 1: Japanese Patent No. 3073590

Document 2: International Publication Number WO 00/63860 (International publication date: 26 Oct. 2000, International application number: PCT/US00/10414

Document 3: Japanese Laid Open Patent Application Publication No. 2001-266480

### DISCLOSURE OF THE INVENTION

The object of the present invention is to provide a contents distribution system, a signature apparatus, a contents supply apparatus, a contents recording apparatus, a contents playback apparatus, a contents recording method, a contents playback method, a computer program and recording medium that prevent illegal use of sub-content related to the main content recorded on a portable ROM medium.

In order to achieve the stated object, the present invention is a contents distribution system in which sub-content relating to main content is distributed, and is composed of a contents supply apparatus and a contents playback apparatus.

The contents supply apparatus outputs sub-content that relates to main content. The contents playback apparatus acquires the sub-content from the contents supply apparatus, and judges, using information about main content recorded on the portable recording medium, whether the sub-content is legal sub-content. When the sub-content is judged to be legal, the contents playback apparatus plays the sub-content.

This structure prevents illegal usage of sub-content relating to main content.

### BRIEF DESCRIPTION OF THE DRAWINGS

FIG. 1 is a block diagram showing the structure of a contents distribution system 1;

FIG. 2 is a block diagram showing the structure of a DVD manufacturing apparatus 100;

FIG. 3 shows one example of information recorded on a DVD 500;

FIG. 4 is a block diagram showing the structure of a contents supply apparatus 200;

FIG. 5 is a block diagram showing the structure of a main player 300;

FIG. 6 is a block diagram showing the structure of a memory card 600;

FIG. 7 is a block diagram showing the structure of a sub-player 400;

FIG. 8 is a flowchart showing operations by the DVD manufacturing apparatus 100;

FIG. 9 is a flowchart showing operations by the main player 300 for acquiring sub-content, and continues in FIG. 10;

FIG. 10 is a flowchart showing operations by the main player 300 for acquiring sub-content, and continues in FIG. 11;

FIG. 11 is a flowchart showing operations by the main player 300 for acquiring sub-content, and continues from FIG. 10;

FIG. 12 is a flowchart showing operations for mutual authentication between the contents supply apparatus 200 and the main player 300;

FIG. 13 is a flowchart showing operations by the main player 300 for playing back sub-content;

FIG. 14 is a flowchart showing operations by the sub-player 400 for playing back sub-content, and continues in FIG. 15;

FIG. 15 is a flowchart showing operations by the sub-player 400 for playing back sub-content, and continues from FIG. 14;

FIG. 16 is a flowchart showing operations for mutual authentication between the sub-player 400 and the memory card 600;

FIG. 17 shows the structure and operations of a contents distribution system 1b as an example of a modification;

FIG. 18 is a block diagram showing the structure of a contents distribution system 2;

FIG. 19 is a block diagram showing the structure of a contents supply apparatus 800;

FIG. 20 shows a subtitle overlay table as one example of sub-content;

FIG. 21 is a block diagram showing the structure of a BD manufacturing apparatus 700;

FIG. 22 is a block diagram showing the structure of a main player 900;

FIG. 23 is a block diagram showing the memory card 650;

FIG. 24 is a block diagram showing the structure of a sub-player 1000;

FIG. 25 is a flowchart showing operations by the contents supply apparatus 800;

FIG. 26 is a flowchart showing operations when the BD manufacturing apparatus 700 authorizes sub-content;

FIG. 27 is a flowchart showing operations when the main player 900 performs linked playback;

FIG. 28 is a flowchart showing operations when the sub-player 1000 performs linked playback;

FIG. 29 shows an audio replacement table as an example of application of the sub-content;

FIG. 30 shows a playback order table as an example of application of the sub-content;

FIG. 31 shows a subtitle data table as an example of application of the sub-content;

FIG. 32 shows an example of a screen when performing linked playback of the sub-content; and

FIG. 33 shows an example of application of the sub-content.

### BEST MODE FOR CARRYING OUT THE INVENTION

### 1. First Embodiment

The following describes a contents distribution system 1 as one embodiment of the present invention.

1.1 Structure of the Contents Distribution System 1

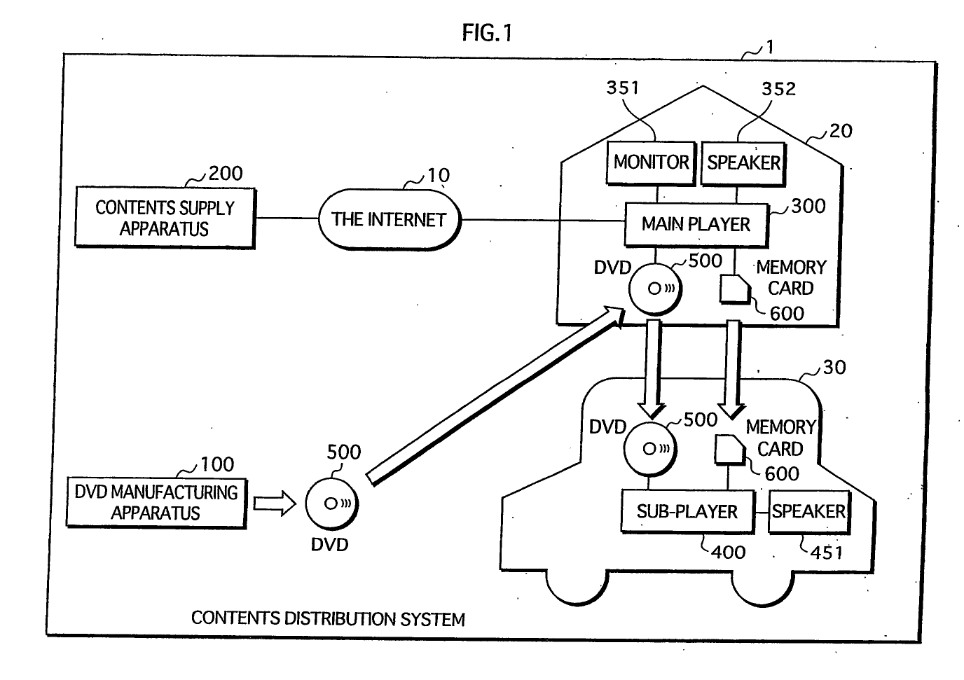

The contents distribution system 1, as shown in FIG. 1, is composed of a DVD manufacturing apparatus 100, a contents supply apparatus 200, a main player 300, and a sub-player 400.

The DVD manufacturing apparatus 100, which is owned by a DVD manufacturer, writes main content to a DVD. Here, DVD refers to a ROM-type recording medium to which information can be written only once. Furthermore, an example of main content is movie information composed of digital video data and digital audio data. A DVD 500 to which main content has been written is sold by a seller. A user purchases, and thus owns, the DVD 500.

The contents supply apparatus 200, which is owned by a sub-contents supplier, distributes sub-content that relates to the main content via the Internet 10 to a user for a charge. Sub-content is content that relates to the main content. Examples of sub-content include video and audio information of a preview of a movie that is main content, subtitle information that expresses in characters the script spoken by the performers in the movie, and information regarding the performers in the movie.

The main player 300, which is owned by the user, is set in the house in which the user lives. A monitor 351 and a speaker 352 are connected to the main player 300. The user mounts the purchased DVD 500 in the main player 300. According to user operations, the main player 300 plays back the main content recorded on the DVD 500, and outputs video and audio to the monitor 351 and the speaker 352. Furthermore, the main player 300 is connected to the Internet 10, and according to the user operations, acquires sub-content that relates to the main content recorded on the DVD 500 from the contents supply apparatus 200, and writes the acquired sub-content to a memory card 600.

The sub-player 400, which is owned by the user, is provided in the user's car. The sub-player 400 includes a monitor (not illustrated), and a speaker 451. The user mounts the purchased DVD 500 in the sub-player 400. According to user operation, the sub-player 400 plays back the main content recorded on the DVD 500, and outputs video and audio to the internal monitor and the speaker 451. Furthermore, the user mounts both the purchased DVD 500 and the memory card 600 in the sub-player 400. The sub-player 400, according to user operation, reads the sub-content from the memory card 600, and plays back the read sub-content, only when both the DVD 500 and the memory card 600 are mounted in the sub-player 400.

1.2 Structure of the DVD Manufacturing Apparatus 100

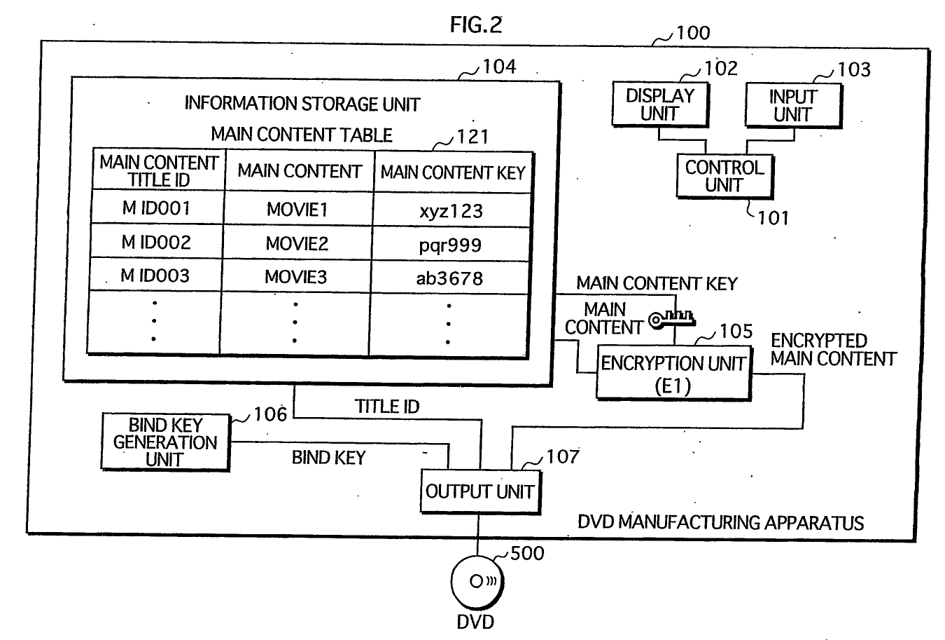

The DVD manufacturing apparatus 100, as shown in FIG. 2, is composed of a control unit 101, a display unit 102, an input unit 103, an information storage unit 104, an encryption unit 105, a bind key generation unit 106 and an output unit 107.

The DVD manufacturing apparatus 100 is specifically a computer system composed of a microprocessor, a ROM, a RAM, a hard disk unit, a display unit, a keyboard and so on. The RAM and the hard disk unit store computer programs. The DVD manufacturing apparatus 100 achieves its functions by the microprocessor operating according to the computer programs.

Note that each block in FIG. 2 is connected to other blocks by connection lines, but some of these connection lines are omitted in FIG. 2. Here, each connection line shows a path by which signals and information are conveyed. Furthermore, among the plurality of connection lines connected to the block that shows the encryption unit 105, those that have a key mark thereon show paths by which information is conveyed to the encryption unit 105 as a key. This also applies to other drawings.

(1) Information Storage Unit 104

The information storage unit 104 is specifically composed of a hard disk unit. The information storage unit 104, as shown in FIG. 2, has a main content table 121. The main content table 121 includes a plurality of pieces of main content information that are each composed of a main content title ID, main content, and a main content key.

Here, the main content is, as one example, movie information composed of digital video data and digital audio data.

The main content title ID is an identification number that uniquely identifies the main content. One example of the main content title ID is “MID001” as shown in FIG. 2. Here, the first character “M” of “MID001” is an identification code that shows that the content is main content. The character string “ID” that follows “M” is an identification code that shows that the title ID is a title identifier. Furthermore, the character string “001” that follows “ID” is a number for identifying the main content.

The main content key is information that is used as a key when encrypting the main content. The main content key is supplied by some means to a user who legally purchases a DVD on which is recorded encrypted main content that has been encrypted using the main content key. Note that since the supply of the main content key to the user is not the subject of the present invention, a description thereof is omitted.

(2) Control unit 101, Display Unit 102 and Input Unit 103

The input unit 103 receives from an operator an operation to write the main content to a DVD, and the title ID of the main content. The input unit 103 outputs instruction information shown by the received operation, and the main content title ID to the control unit 101.

The control unit 101 receives the instruction information and the main content title ID, and controls the encryption unit 105, the bind unit 106 and the output unit 107 based on the received instruction information and main content title ID.

The display unit 102 displays various information according to control by the control unit 101.

(3) Encryption Unit 105

The encryption unit 105 has, as one example, an encryption algorithm E1 specified by DES (Data Encryption Standard).

The encryption unit 105, based on control by the control unit 101, reads from the main content table 121 the main content and the main content key that correspond to the main content title ID for which the input unit 103 received the input. The encryption unit 105 generates encrypted main content by applying the encryption algorithm E1 to the read main content using the read main content key as the key, and outputs the generated encrypted main content to the output unit 107.

(4) Bind Key Generation Unit 106

The bind key generation unit 106, based on control by the control unit 101, generates a random number for each DVD, and outputs the each generated random number to the output unit 107 as a bind key.

Note that it is possible to generate bind keys so that a plurality of DVDs have the same bind key, rather than generating a separate bind key for each DVD.

(5) Output Unit 107

The output unit 107 receives the main content title ID from the control unit 101. Furthermore, the output unit 107, based on control by the control unit 101, receives the encrypted main content from the encryption unit 105, and receives the bind key from the bind key generation unit 106.

Next, the output unit 107, based on control by the control unit 101, writes the received main content title ID, the bind key and the encrypted main content in correspondence to the DVD.

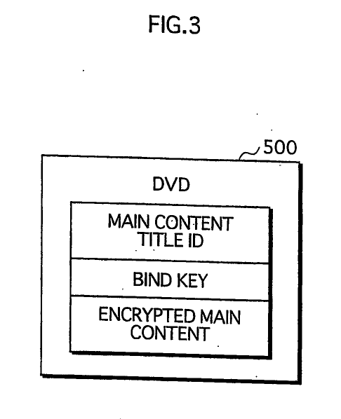

In this way, the DVD 500 on which the main content title ID, the bind key and the encrypted main content are recorded, as shown in FIG. 3, is manufactured.

1.3 Structure of the Contents Supply Apparatus 200

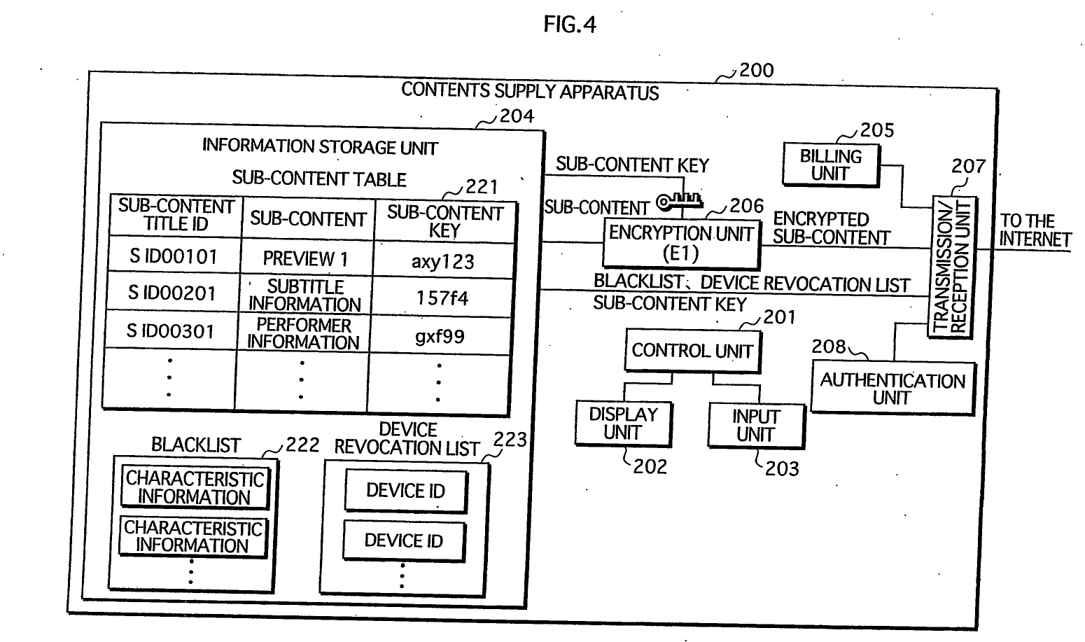

The contents supply apparatus 200, as shown in FIG. 4, is composed of a control unit 201, a display unit 202, an input unit 203, an information storage unit 204, a billing unit 205, an encryption unit 206, a transmission/reception unit 207 and an authentication unit 208.

The contents supply apparatus 200 is a computer similar to the DVD manufacturing apparatus 100. The contents supply apparatus 200 achieves its functions by a microprocessor operating according to computer programs.

(1) Information Storage Unit 204

The information storage unit 204 is specifically composed of a hard disk unit. The information storage unit 204, as shown in FIG. 4, has a sub-content table 221, a blacklist 222 and a device revocation list 223.

<Sub-Content Table 221>

The sub-content table 221, as shown in FIG. 4, includes a plurality of pieces of sub-content information that are each composed of a sub-content title ID, sub-content, and a sub-content key.

Here, the sub-content is information that relates to the main content, specifically a preview of a movie, subtitle information, information regarding performers in the movie, or the like, as described earlier. The sub-content title ID is an identification number that uniquely identifies the sub-content. One example of the sub-title ID is “SID00101” as shown in FIG. 4. Here, the first character “S” of “SID00101” is an identification code that shows that the content is sub-content. The character string “ID” that follows “S” is an identification code that shows that the title ID is a title identifier. Furthermore, the character string “001” that follows “ID” is a number for identifying the main content that relates to the sub-content. Furthermore, the character string “01” that follows “001” is a number for identifying the sub-content. In this way, information for designating the title ID of the related main content is included in the sub-content title ID. Therefore, if the sub-content title ID is known, the related main content title ID is also known. Conversely, if the main content title ID is known, the related sub-content title ID is known.

According to the above-described rules of naming for the title ID, a plurality of sub-contents can be associated with one main content.

Note that the rules for naming the title ID are not limited to those described above. It is possible to associate a plurality of sub-contents with a plurality of main contents.

The sub-content key is information used as a key when encrypting the sub-content.

<Blacklist 222>

The blacklist 222 includes information that identifies illegal recording media on which illegal content that is illegally copied main content is recorded, in other words, pirate disks. Specifically, the blacklist is composed of a plurality of pieces of characteristic information, as shown in FIG. 4.

The characteristic information is composed of sections of illegal data video data and illegal audio data recorded on a pirate disk that are characteristic of the illegal data and are extracted by analyzing the illegal data. The characteristic information is information that is not included in the legal digital video data or the digital audio data.

When characteristic information is extracted from digital data recorded on a recording medium, it is presumed that the recording medium is a pirate disk.

<Device Revocation List 223>

The device revocation list 223 is provided so that writing apparatuses that write information to recording media and playback apparatuses that playback information from recording media can be prevented from being used illegally after their secret key or encryption or decryption system has been illegally exposed to a third party.

The device revocation list 223, as shown in FIG. 4, includes a plurality of device IDs. Each device ID is a identification number for identifying a device whose secret key or encryption or decryption system has been illegally exposed to a third party.

(2) Control Unit 201

The control unit 201 receives a user ID, a sub-content acquisition request and a main content title ID from the main player 300 via the Internet 10 and the transmission/reception unit 207.

On receiving the user ID, the sub-content acquisition request and the main content title ID from the main player 300, the control unit 201 controls the authentication unit 208 so that the authentication unit 208 performs mutual device authentication with the main player 300.

Next, only when device authentication by the authentication unit 208 succeeds, the control unit 201 generates a sub-content search title ID, based on the received main content title ID. Specifically, when the main content title ID is “MID001”, the control unit 201 extracts the section “001” from “MID001”, and generates the sub-content search title ID by combining the identification code “S”, the identification code “ID” and the extracted section “001”. Next, the control unit 201 uses a forward match search method to extract the sub-content information that includes the sub-content title ID that matches the search title ID from the sub-content table 221. Furthermore, the control unit 201 extracts the sub-content title ID from the sub-content information acquired by extracting. Next, the control unit 201 outputs the user ID, a sub-content acquisition request and the sub-content title ID to the billing unit 205, and controls so that the billing unit 205 performs billing processing.

Next, the control unit 201 outputs the extracted sub-content title ID to the encryption unit 206, and controls so that the encryption unit 206 encrypts the sub-content.

Furthermore, the control unit 201 outputs the extracted sub-content title ID to the transmission/reception unit 207, and controls so that the transmission/reception unit 207 transmits the sub-content tile ID, the encrypted sub-content, the sub-content key, the blacklist and the device revocation list.

(3) Billing Unit 205

The billing unit 205 receives the user ID, the sub-content acquisition request, and the sub-content title ID from the control unit 201. On receiving the user ID, the sub-content acquisition request, and the sub-content title ID, the billing unit 205 bills the user shown by the received user ID for the sub-content shown by the received sub-content title ID.

(4) Authentication Unit 208

The authentication unit 208 performs mutual device authentication with an authentication unit 304 of the main player 300.

When the authentication unit 208 fails in device authentication, the contents supply apparatus 200 ends the sub-content supply process. When the authentication unit 208 succeeds in device authentication, the contents supply apparatus 200 continues the sub-content supply processing.

Details of authentication operations by the authentication unit 208 are described later.

(5) Encryption Unit 206

Based on control by the control unit 201, the encryption unit 206 reads the sub-content information that includes the sub-content title ID from the information storage unit 204, and extracts the sub-content and the sub-content key from the read sub-content information.

Next, based on control by the control unit 201, the encryption unit 206 generates encrypted sub-content by applying the encryption algorithm E1 to the sub-content using the sub-content key as the key, and outputs the generated encrypted sub-content and the sub-content key to the transmission/reception unit 207.

(6) Transmission/Reception Unit 207

Based on control by the control unit 201, the transmission/reception unit 207 reads the blacklist 222 and the device revocation list 223 from the information storage unit 204.

Next, based on control by the control unit 201, the transmission/reception unit 207 transmits the sub-content title ID, the encrypted sub-content, the sub-content key, the blacklist and the device revocation list via the Internet 10 to the main player 300.

(7) Display Unit 202 and the Input Unit 203

The display unit 202 displays various information, based on control by the control unit 201.

The input unit 203 receives inputs from the user, and outputs the received input information to the control unit 201.

1.4 Structure of the Main Player 300

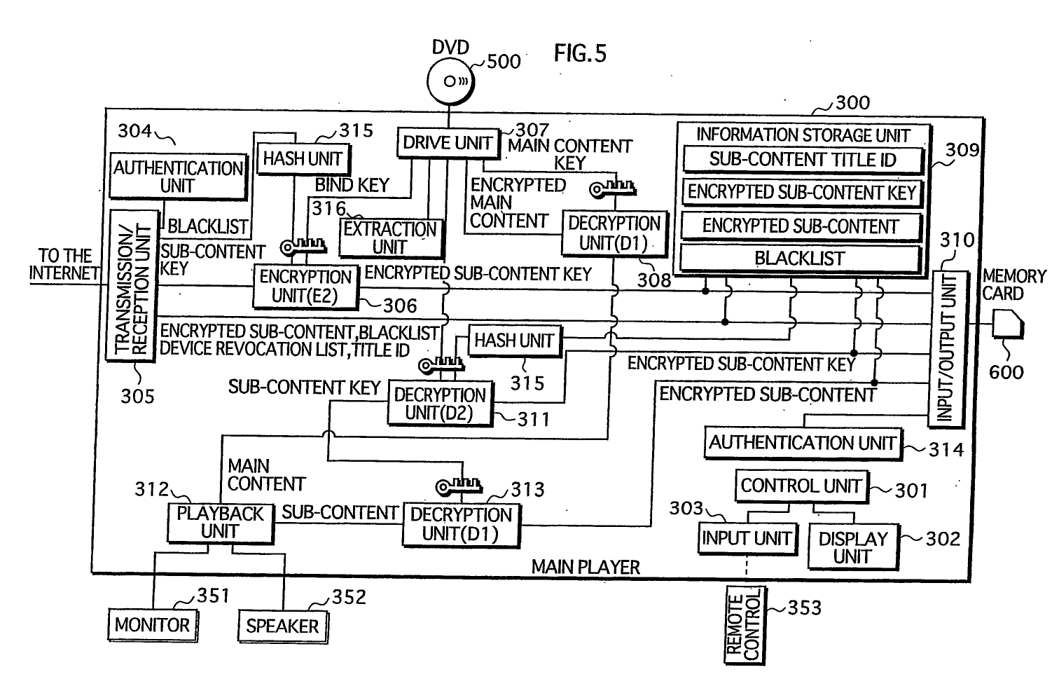

As shown in FIG. 5, the main player 300 is composed of a control unit 301, a display unit 302, an input unit 303, an authentication unit 304, a transmission/reception unit 305, an encryption unit 306, a drive unit 307, a decryption unit 308, an information storage unit 309, an input/output unit 310, a decryption unit 311, a playback unit 312, a decryption unit 313, an authentication unit 314, a hash unit 315 and an extraction unit 316. A monitor 351 and a speaker 352 are connected to the playback unit 312.

The main player 300 is a computer system similar to the DVD manufacturing apparatus 100. The main player 300 achieves its functions by a microprocessor operating according to computer programs.

(1) Information Storage Unit 309

The information storage unit 309 is specifically composed of a hard disk unit, and, as shown in FIG. 5, includes areas for storing a sub-content title ID, an encrypted sub-content key, encrypted content and a blacklist.

The sub-content title ID is identification information for uniquely identifying sub-content.

The encrypted sub-content key is a sub-content key that has been encrypted.

The encrypted sub-content is sub-content that has been encrypted.

Here, the title ID, the encrypted sub-content key and the encrypted sub-content are in correspondence.

As described earlier, the blacklist includes information that identifies illegal recording media on which illegal content that is illegally copied main content is recorded, in other words, pirate disks. Specifically, the blacklist is composed of a plurality of pieces of characteristic information.

(2) Input Unit 303

When sub-content is to be acquired, the input unit 303 receives a sub-content acquisition request from the user, and outputs the received acquisition request to the control unit 301.

When sub-content is to be played back, the input unit 303 receives input of the title ID of the sub-content to be played back, from the user via a remote control 353, and outputs the title ID of which input was received to the control unit 301.

(3) Control Unit 301

When sub-content is to be acquired, the control unit 301 receives the acquisition request from input unit 303, controls the drive unit 307 so that the main content title ID is read from the DVD 500, and receives the main content title ID from the drive unit 307. Next, the control unit 301 transmits an internally-stored user ID, the sub-content acquisition request and the main content title ID via the transmission/reception unit 305 and the Internet 10 to the contents supply apparatus 200. Here, the user ID is identification information for uniquely identifying the user.

In addition, the control unit 301 receives authentication result information showing either authentication success or failure, from the authentication unit 314, and controls the various compositional elements based on the received authentication result information.

In addition, when sub-content is to be played back, the control unit 301 outputs the received sub-content title ID to the drive unit 307.

(4) Transmission/Reception Unit 305

The transmission/reception unit 305 receives the sub-content title ID, the encrypted sub-content, the sub-content key, the blacklist, and the device revocation list from the contents supply apparatus 200 via the Internet 10, and, based on control by the control unit 301, outputs the received sub-content key to the encryption unit 306, outputs the received encrypted sub-content to the input/output unit 310, outputs the received blacklist and device revocation list to the input/output unit 310, and outputs the received blacklist to the hash unit 315.

Furthermore, the transmission/reception unit 305 writes the received content title ID and the received encrypted sub-content to the information storage unit 309.

(5) Authentication Unit 304

The authentication unit 304 performs mutual device authentication with the authentication unit 208 of the contents supply apparatus 200.

When the authentication unit 304 fails in device authentication, the main player 300 ends the sub-content acquisition process. When the authentication unit 304 succeeds in device authentication, the main player 300 continues the sub-content acquisition processing.

Details of authentication operations by the authentication unit 304 are described later.

(6) Drive Unit 307

According to control by the control unit 301, the drive unit 307 reads the main content title ID from the DVD 500, and outputs the read main content title ID to the control unit 301.

The drive unit 307 reads the bind key that corresponds to the main content title ID from the DVD 500, and outputs the read bind key to the encryption unit 306.

When sub-content is to be played back, the drive unit 307 receives the main content title ID from the control unit 301, reads from the DVD 500 the bind key that corresponds to the received main content title ID, and outputs the read bind key to the decryption unit 311.

(7) Hash Unit 315

The hash unit 315 receives the blacklist from the transmission/reception unit 305, calculates a hash value H by applying a function Hash to the blacklist, and outputs the calculated hash value H to the encryption unit 306.

The hash unit 315 reads the blacklist that corresponds to the sub-content title ID from the information storage unit 309.

When the extraction unit 316 judges that generated characteristic information is not included on the read blacklist, the hash unit 315 reads the blacklist from the information storage unit 309, generates a hash value H=Hash (blacklist) by applying the hash function Hash to the read blacklist, and outputs the generated hash value H to the decryption unit 311.

(8) Encryption Unit 306

The encryption unit 306 receives the bind key from the drive unit 307, receives the hash value H from the hash unit 315, and receives the sub-content key from the transmission/reception unit 305. Next, the encryption unit 306 generates a key by connecting the received hash value H and the received bind key in the stated order, and generates an encrypted sub-content key by applying the encryption algorithm E2 to the received sub-content key with use of the generated key. Here, the encryption algorithm E2 is a DES encryption algorithm.

Next, the encryption unit 306 outputs the generated encrypted sub-content key to the input/output unit 310. In addition, the encryption unit 306 writes the generated encrypted sub-content key to the information storage unit 309.

(9) Authentication Unit 314

When information is to be written to the memory card 600, the authentication unit 314 performs mutual device authentication with an authentication unit 602 of the memory card 600.

When the authentication unit 314 fails in device authentication with the authentication unit 602 of the memory card 600, the main player 300 ends processing for accessing the memory card 600.

Only when the authentication unit 314 succeeds in authentication with the authentication unit 602 of the memory card 600, the main player continues further processing for accessing the memory card 600.

The authentication unit 314 outputs authentication result information showing authentication success or failure to the control unit 301.

(10) Input/Output Unit 310

Only when device authentication by the authentication unit 314 is successful, the input/output unit 310 receives the sub-content title ID from the control unit 301, receives the encrypted sub-content, the blacklist and the device revocation list from the transmission/reception unit 305, receives the encrypted sub-content from the encryption unit 306, and outputs the received sub-content title ID, the encrypted sub-content key, the encrypted sub-content, the blacklist and the device revocation list to the memory card 600.

(11) Decryption Unit 311

The decryption unit 311 reads the encrypted sub-content key that corresponds to the sub-content title ID from the information storage unit 309.

Furthermore, the decryption unit 311 receives the bind key from the drive unit 307, receives the hash value H from the hash unit 315, and generates a key by connecting the received hash value H and the received bind key in the stated order. Next, the decryption unit 311 generates a sub-content key by applying a decryption algorithm D2 to the read encrypted sub-content key using the generated key, and outputs the generated sub-content key to the decryption unit 313.

Here, the decryption algorithm D2 corresponds to the encryption algorithm E2, and is an algorithm for decrypting a ciphertext encrypted by the encryption algorithm E2.

(12) Decryption Unit 313

The decryption unit 313 reads the encrypted sub-content that corresponds to the sub-content title ID from the information storage unit 309.

Next, the decryption unit 313 receives the sub-content key from the decryption unit 311, generates sub-content by applying a decryption algorithm D1 to the read encrypted sub-content using the received sub-content key, and outputs the generated sub-content to the playback unit 312.

Here, the decryption algorithm D1 corresponds to the encryption algorithm E1, and is an algorithm for decrypting a ciphertext encrypted by the encryption algorithm E1.

(13) Extraction Unit 316

The extraction unit 316 reads the main content from the DVD 500 via the drive unit 307, and extracts a characteristic from the read main content to generate characteristic information. Then, the extraction unit 316 reads the blacklist from the information storage unit 309, and judges whether generated characteristic information is included on the read blacklist. When the characteristic information is judged to be included, the DVD 500 is considered to be a pirate disk, and the extraction unit 316 outputs an instruction to the control unit 301 to stop subsequent processing. When the characteristic information is judged not to be included, the extraction unit 316 outputs an instruction to the control unit 301 to continue processing.

(14) Playback Unit 312

The playback unit 312 receives sub-content, generates a video signal from the received sub-content and outputs the generated video signal to the monitor 351, and also generates an audio signal from the received sub-content and outputs the generated audio signal to the speaker 352.

1.5 Structure of the Memory Card 600

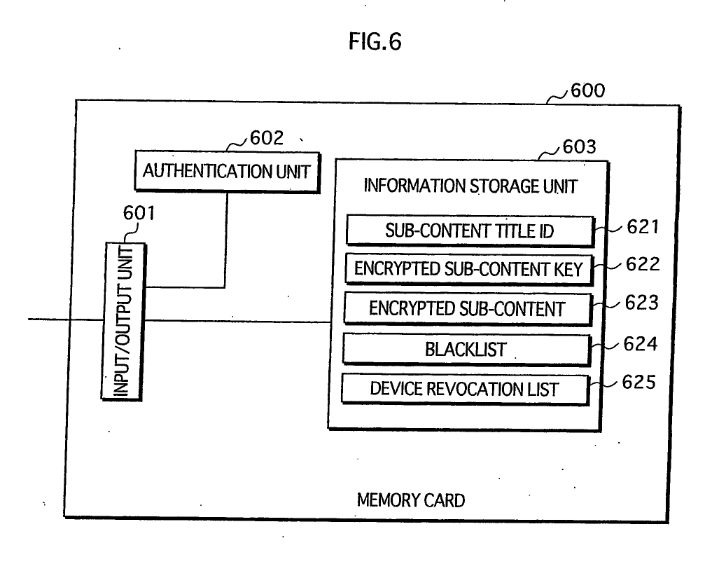

As shown in FIG. 6, the memory card 600 is composed of an input/output unit 601, the authentication unit 602, and an information storage unit 603.

The memory card 600 is a computer system similar to the DVD manufacturing apparatus 100. The memory card 600 achieves its functions by a microprocessor operating according to computer programs.

The memory card 600 mounted in the main player 300 or the sub-player 400.

The memory card 600 receives information from whichever of the main player 300 and the sub-player 400 it is mounted in, and writes the received information to the information storage unit 603.

Furthermore, following instructions from the main player 300 or the sub-player 400, the memory card 600 reads information from the information storage unit 603, and outputs the read information to the main player 300 or the sub-player 400.

(1) Information Storage Unit 603

As shown in FIG. 6, the information storage unit 603 has areas for storing a sub-content title ID 621, an encrypted sub-content key 622, encrypted sub-content 623, a blacklist 624 and a device revocation list 625.

These are the same as was described earlier, and therefore descriptions are omitted.

(2) Input/Output Unit 601

The input/output unit 601 performs input and output of information between the information storage unit 603 and the main player 300, or between the information storage unit 603 and the sub-player 400.

(3) Authentication Unit 602

When the memory card 600 is mounted in the main player 300, the authentication unit 602 performs mutual device authentication with the authentication unit 314 of the main player 300. The authentication unit 602 continues subsequent processing only when authentication succeeds. When authentication fails, the authentication unit 602 ends processing.

When the memory card 600 is mounted in the sub-player 400, the authentication unit 602 performs mutual device authentication with the authentication unit 414 of the sub-player 400. The authentication unit 602 continues subsequent processing only when authentication succeeds. When authentication fails, the authentication unit 602 ends processing.

1.6 Structure of the Sub-Player 400

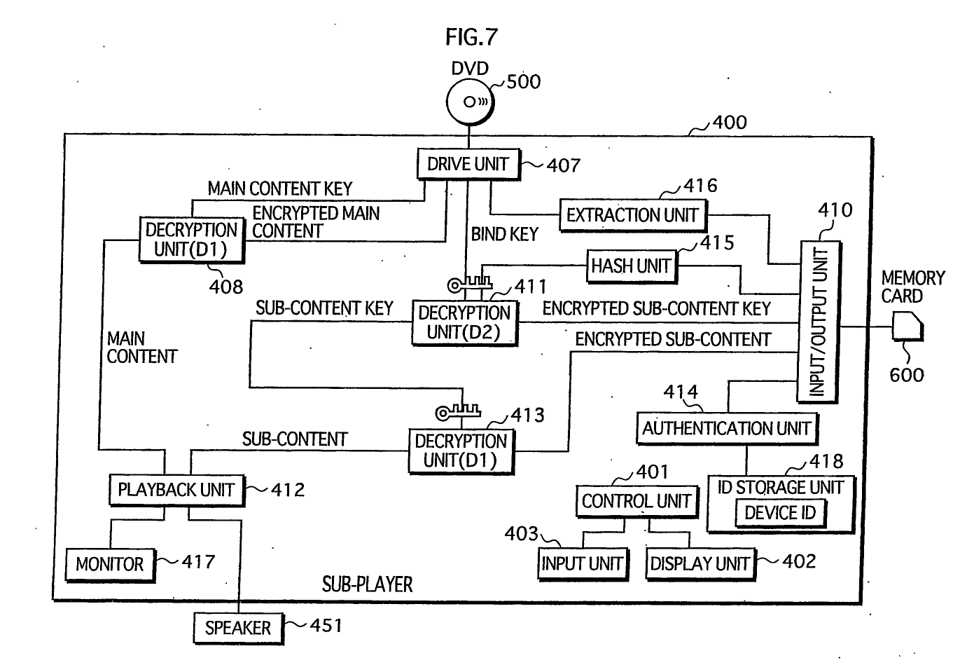

As shown in FIG. 7, the sub-player 400 is composed of a control unit 401, a display unit 402, an input unit 403, a drive unit 407, a decryption unit 408, an input/output unit 410, a decryption unit 411, a playback unit 412, a decryption unit 413, the authentication unit 414, a hash unit 415, an extraction unit 416, a monitor unit 417 and an ID storage unit 418.

The sub-player 400 is a computer system similar to the DVD manufacturing apparatus 100. The sub-player 400 achieves its functions by a microprocessor operating according to computer programs.

(1) Input Unit 403

The input unit 403 receives designation of sub-content to be played back from the user, and acquires the title ID of the designated sub-content from the memory card 600 via the input/output unit 410. Next, the input unit 403 outputs the acquired sub-content title ID to the control unit 401.

(2) Control Unit 401

The control unit 401 receives the sub-content title ID, and generates a main content title ID based on the received sub-content title ID. Here, the method used for generating the main content title ID is based on the rules for naming a title ID described earlier. Next, the control unit 401 outputs the generated main content title ID to the drive unit 407.

(3) Drive Unit 407

The drive unit 407 receives the main content title ID from the control unit 401, reads the bind key that corresponds to the received main content title ID from the DVD 500, and outputs the read bind key to the decryption unit 411.

(4) Authentication Unit 414

The authentication unit 414 performs mutual device authentication with the authentication unit 602 of the memory card 600. When device authentication succeeds, the authentication unit continues subsequent processing. When device authentication fails, the various apparatuses stop subsequent processing.

(5) Input/Output Unit 410

When mutual device authentication succeeds, the input/output unit 410 outputs a request to the memory card 600 to read the blacklist, the encrypted sub-content key and the encrypted sub-content.

Next, the input/output unit 410 receives the blacklist, the encrypted sub-content key and the encrypted sub-content key from the memory card 600.

(6) Extraction Unit 416

The extraction unit 416 reads the main content from the DVD 500 via the drive unit 407, and generates characteristic information by extracting a characteristic from the read main content. Next, the extraction unit 416 receives the blacklist from the input/output unit 410, and judges whether the generated characteristic information is includes in the blacklist.

When the characteristic information is judged to be included, the DVD 500 is considered to be a pirate disk, and the extraction unit 416 outputs an instruction to the control unit 401 to stop subsequent processing. At this point, the control unit 401 controls the various compositional elements so as to stop subsequent processing. In this way, the sub-player 400 stops playback of the sub-content.

When the characteristic information is judged to not be included on the blacklist, processing continues.

(7) Hash Unit 415

When the extraction unit 416 judges that the generated characteristic information is not included on, the blacklist, the hash unit 415 receives the blacklist form the input/output unit 410, generates a hash value H=Hash (blacklist) by applying a function Hash to the blacklist, and outputs the generated hash value H to the decryption unit 411.

(8) Decryption Unit 411

The decryption unit 411 receives the bind key from the drive unit 407, receives the hash value H from the hash unit 415, generates a key by connecting the received hash value H and the received bind key in the stated order, generates a sub-content key by applying the decryption algorithm D2 to the read encrypted sub-content key with use of the generated key, and outputs the generated sub-content key to the decryption unit 413.

(9) Decryption Unit 413

The decryption 413 receives encrypted sub-content from the input/output block 410. In addition, the decryption unit 413 receives the sub-content key from the decryption unit 411, generates sub-content by applying the decryption algorithm D1 to the received encrypted content using the received sub-content key, and outputs the generated sub-content to the playback unit 412.

(10) Playback Unit 412

The playback unit 412 receives the sub-content from the decryption unit 413, generates a video signal from the received sub-content and outputs the generated video signal to the monitor 417, and also generates an audio signal from the received sub-content and outputs the generated audio signal to the speaker 451.

1.6 Operations by the DVD Manufacturing Apparatus 100

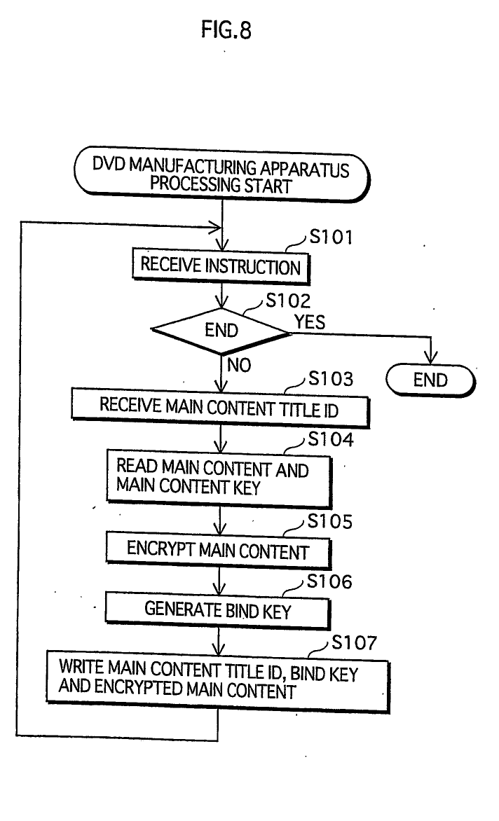

The following describes operations by the DVD manufacturing apparatus 100 with use of the flowchart in FIG. 8.

The input unit 103 receives an operation for writing to a DVD or an operation for ending writing to a DVD from an operator, and outputs instruction information showing the received operation to the control unit 101 (step S101).

When the control unit 101 receives instruction information showing ending writing to a DVD (step S102), the control unit 101 ends processing by the DVD manufacturing apparatus 100.

When the control unit 101 receives instruction information showing writing to a DVD (step S102), the input unit 103 additionally receives the main content title ID from the user and outputs the received main content title ID to the control unit 101, and the control unit 101 receives the title ID (step S103).

Next, based on control by the control unit 101, the encryption unit 105 reads from the main content table 121 the main content and main content key that are in correspondence with the title ID of which input was received (step S104). The encryption unit 105 generates encrypted main content by applying the encryption algorithm E1 to the read main content using the read content key as the key, and outputs the generated encrypted main content to the output unit 107 (step S105).

Next, based on control by the control unit 101, the bind key generation unit 106 generates a random number that is unique to the DVD, and outputs the generated random number to the output unit 107 as the bind key (step S106).

Next, the output unit 107 receives the title ID from the control unit 101, receives the encrypted main content form the encryption unit 105, receives the bind key from the bind key generation unit 106, and then writes the received main content title ID, bind key and encrypted main content to the DVD (step S107). Next, the DVD manufacturing apparatus 100 returns to step S101 and repeats the processing.

1.7 Operations by the Main Player 300 for Acquiring Sub-Content

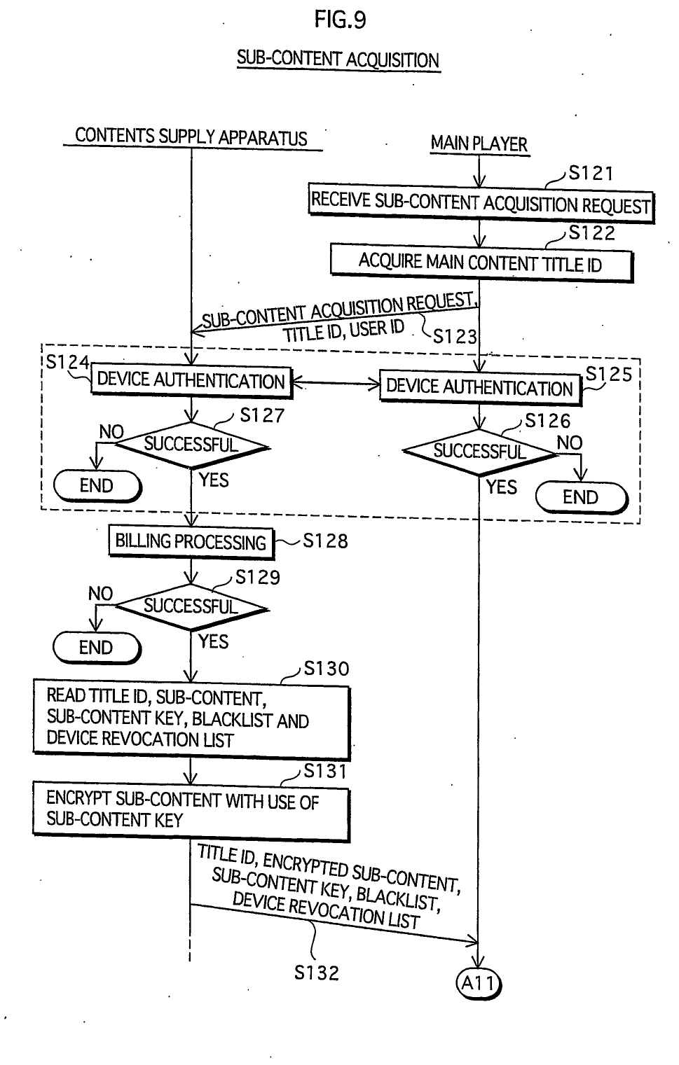

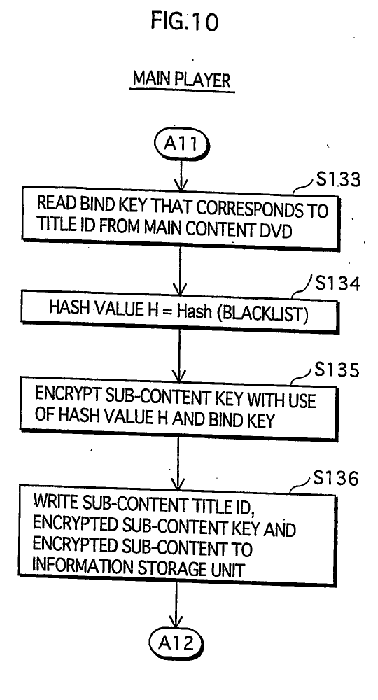

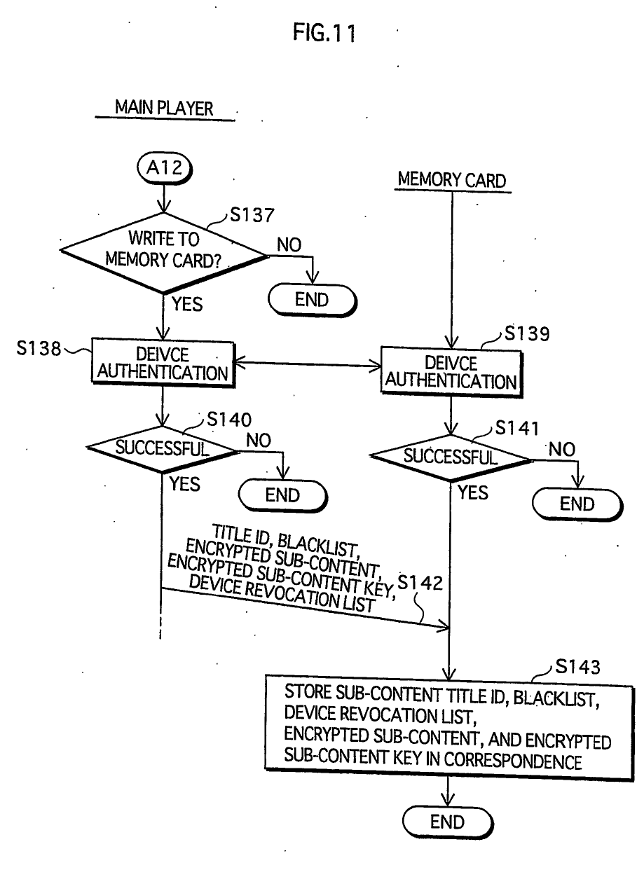

The following describes operations by the main player 300 for acquiring sub-content, with use of the flowcharts in FIGS. 9 to 11.

The input unit 303 of the main player 300 receives an acquisition request for sub-content from the user, and outputs the received acquisition request to the control unit 301. The control unit 301 receives the acquisition request from the input unit 303 (step S121). In addition, the control unit 301 controls the drive unit 307 so that the drive unit 307 reads the title ID, and the control unit 301 receives the title ID from the drive unit 307 (step S122).

Next, the control unit 301 transmits the internally-stored user ID, the sub-content acquisition request and the main content title ID to the contents supply apparatus 200 via the transmission/reception unit 305 and the Internet 10 (step S123).

Next, the control unit 201 of the contents supply apparatus 200 receives the user ID, the sub-content acquisition request and the main content title ID from the main player 300 via the Internet 10 and the transmission/reception unit 207 (step S123).

Next, the authentication unit 304 of the main player 300 and the authentication unit 208 of the contents supply apparatus 200 perform mutual device authentication (steps S124, S125).

When either of the authentication unit 304 and the authentication unit 208 fails in device authentication, or when both fail in device authentication (steps S126, S127), the apparatuses end processing.

Only when both the authentication unit 304 and the authentication unit 208 succeed in device authentication (steps S126, S127), the processing proceeds to the next step.

Next, based on control by the control unit 201, the encryption unit 206 of the contents supply apparatus 200 reads the sub-content information that includes the sub-content title ID from the information storage unit 204, and extracts the sub-content and the sub-content key from the read sub-content information. Based on control by the control unit 201, the transmission/reception unit 207 reads the blacklist 222 and the device revocation list 223 from the information storage unit 204 (step S130).

Next, based on control by the control unit 201, the encryption unit 206 generates encrypted sub-content by applying the encryption algorithm E1 to the sub-content using the sub-content key as the key, and outputs the generated sub-content and the sub-content key to the transmission/reception unit 207 (step S131).

Next, based on control by the control unit 201, the transmission/reception unit 207 transmits the encrypted sub-content, the sub-content key, the blacklist and the device revocation list to the main player 300 via the Internet 10 (step S132).

The transmission/reception unit 305 of the main player 300 receives the encrypted sub-content, the sub-content key, the blacklist and the device revocation list from the contents supply apparatus 200 via the Internet 10, and, based on control by the control unit 301, outputs the received sub-content key to the encryption unit 306, outputs the encrypted sub-content to the input/output unit 310, outputs the blacklist and the device revocation list to the input/output unit 310, and outputs the blacklist to the hash unit 315 (step S132).

The drive unit 307 receives the bind key that corresponds to the main content title ID from the DVD 500, and outputs the read bind key to the encryption unit 306 (step S133). Next, the hash unit 315 receives the blacklist from the transmission/reception unit 305, calculates a hash value H by applying the hash function Hash to the received blacklist, and outputs the calculated hash value H to the encryption unit 306 (step S134).

Next, the encryption unit 306 receives the bind key from the drive unit 307, receives the hash value H from the hash value H, and receives the sub-content key from the transmission/reception unit 305. The encryption unit 306 generates a key by combining the received hash value H and the received bind key in the stated order, and generates an encrypted sub-content key by applying the encryption algorithm E2 to the received sub-content using the generated key (step S135).

Next, the control unit 301 writes the sub-content title ID to the information storage unit 309, the encryption unit 306 writes the encrypted sub-content to the information storage unit 309, and the transmission/reception unit 305 writes the encrypted sub-content to the information storage unit 309 (step S136).

Next, when there is no information to write to the memory card 600 (step S137), the main player 300 ends the sub-content acquisition processing.

On the other hand, when there is information to write to the memory card 600 (step S137), the authentication unit 314 of the main player 300 and the authentication unit 602 of the memory card 600 perform mutual device authentication (step s138, S139).

When the authentication unit 314 or the authentication unit 602 fails in device authentication, or when both fail in device authentication (step S140, s141), the apparatuses end processing.

Only when both the authentication unit 314 and the authentication unit 602 succeed in device authentication (steps S140, S141), the processing proceeds to the next step.

The input/output unit 310 receives the sub-content title ID from the control unit 301, receives the encrypted sub-content, the blacklist and the device revocation list from the transmission/reception unit 305, receives the encrypted sub-content key from the encryption unit 306, and outputs the received sub-content title ID, encrypted sub-content key, encrypted sub-content, blacklist and device revocation list to the memory card 600 (step S142).

The input/output unit 601 of the memory card 600 receives the sub-content title ID, the encrypted sub-content key, the encrypted sub-content, the blacklist and the device revocation list from the main player 300 (step S142), and writes the received sub-content title ID, encrypted sub-content key, encrypted sub-content, blacklist and device revocation list in correspondence in the information storage unit 603 (step S143).

1.8 Operations by the Contents Supply Apparatus 200 and the Main Player 300 for Mutual Authentication

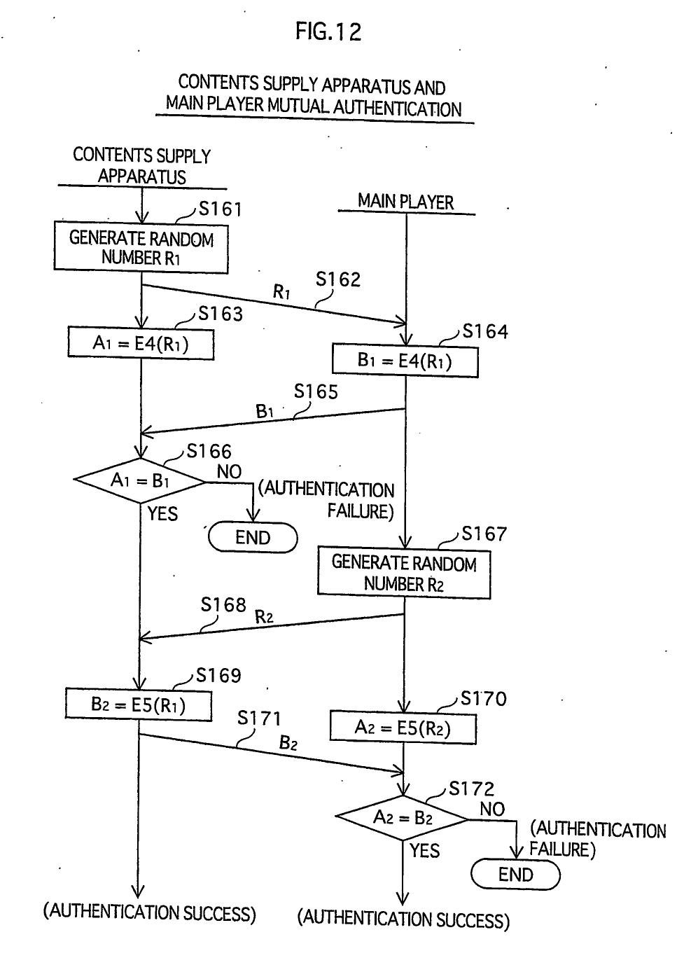

The following describes operations by the contents supply apparatus 200 and the main player 300 for mutual authentication, with use of the flowchart in FIG. 12. Note that the operations for mutual authentication described here are details of operations at steps S124 to S127 in the flowchart in FIG. 9.

Note that the authentication unit 208 of the contents supply apparatus 200 performs transmission and reception of information for mutual authentication with the authentication unit 304 via the transmission/reception unit 207, the Internet 10 and the transmission/reception unit 305 of the main player 300. Likewise, the authentication unit 304 of the main player 300 performs transmission and reception of information for mutual authentication with the authentication unit 208 of the contents supply apparatus 200 via the transmission/reception unit 305, the Internet 10 and the transmission/reception unit 207 of the contents supply apparatus 200. Note that in the following, information is simply described as being transmitted/received between the authentication unit 304 and the authentication unit 208, and mention of the paths therebetween is omitted.

The authentication unit 208 generates a random number R1 (step S161), and transmits the generated random number R1 to the authentication unit 304 (step S162). The authentication unit 208 generates a ciphertext A1 by applying an encryption algorithm E4 to the random number R1 (step s163).

On the other hand, the authentication unit 304 receives the random number R1 from the authentication unit 208 (step S162), and generates a cipher text B1 by applying the encryption algorithm to the received random number R1 (step S164), and transmits the generated ciphertext B1 to the authentication unit 208 (step S165).

Next, the authentication unit 208 receives the ciphertext B1 from the authentication unit 304 (step S165), and judges whether the generated ciphertext A1 and the received ciphertext B1 match. When the two do not match (step S166), the authentication unit 208 considers authentication to have failed, and outputs an instruction to the control unit 201 and the transmission/reception unit 207 to stop subsequent transmission and reception of information with the main player 300.

Meanwhile the authentication unit 304 generates a random number R2 (step S167), transmits the generated random number R2 to the authentication unit 208 (step S168), and generates a ciphertext A2 by applying an encryption algorithm E5 to the generated random number R2 (step S170).

Next, when the authentication unit 208 judges that the generated ciphertext A1 and the received cipher text B1 match (step S166), the authentication unit 208 considers authentication to have succeeded, additionally receives the random number R2 from the authentication unit 304 (step S168), generates a ciphertext B2 by applying the encryption algorithm E5 to the received random number R2 (step S169), and transmits the generated ciphertext B2 to the authentication unit 304 (step S171).

Next, the authentication unit 304 receives the ciphertext B2 from the authentication unit 208 (step S171), judges whether the generated ciphertext A2 and the received ciphertext B2 match, an when the two match (step S172), considers authentication to have failed, and outputs an instruction to the control unit 301 and the transmission/reception unit 305 to stop subsequent transmission and reception of information with the contents supply apparatus 200.

When the two match (step S172), the authentication unit 304 considers authentication to have succeeded.

1.9 Operations by the Main Player 300 for Playing Back Sub-Content.

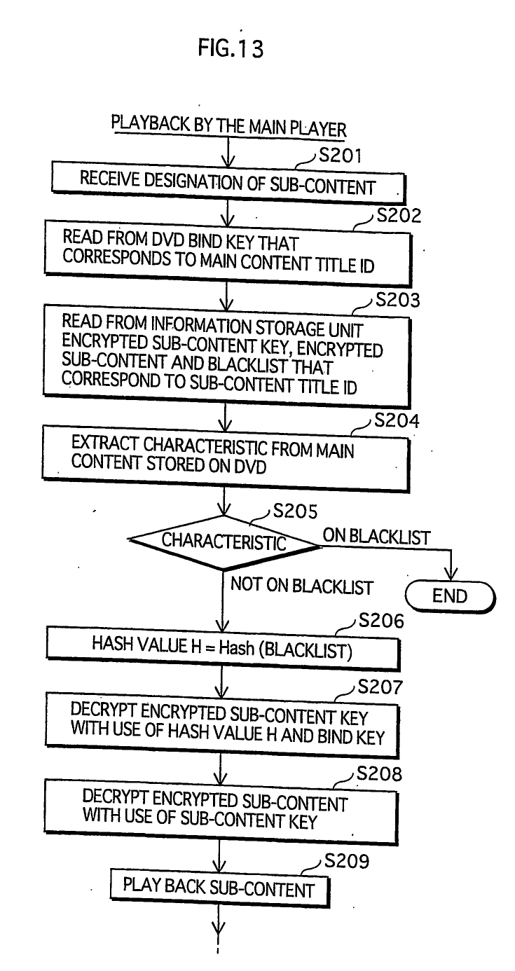

The following describes operations by the main player 300 for playing back sub-content, with use of the flowchart in FIG. 13.

The input unit 303 of the main player 300 receives a designation of sub-content to be played back from the user, acquires the title ID of the sub-content for which the designation was received, and outputs the acquired sub-content title ID to the control unit 301 (step S201).

Next, the control unit 301 generates a main content title ID from the received sub-content title ID, and outputs the generated main content title ID to the drive unit 307. The drive unit 307 receives the title ID from control unit 301, reads the bind key that corresponds to the received title ID from the DVD 500, and outputs the read bind key to the decryption unit 311 (step S202).

Next, the decryption unit 311 reads the encrypted sub-content key that corresponds to the sub-content title ID from the information storage unit 309, the decryption unit 313 reads the encrypted sub-content that corresponds to the sub-content title ID from the information storage unit 309, and the hash unit 315 reads the blacklist that corresponds to the sub-content title ID from the information storage unit 309 (step S203).

Next, the extraction unit 316 reads the encrypted main content from the DVD 500 via the drive unit 307, generates main content by decrypting the encrypted main content, and extracts a characteristic from the generated main content to generate characteristic information (step S204). The extraction unit 316 reads the blacklist from the information storage unit 309, and judges whether the generated characteristic information is included on the blacklist. When the generated characteristic information is included on the blacklist (step S205), the extraction unit 316 considers the DVD 500 to be a pirate disk, and outputs an instruction to the control unit 301 to stop subsequent processing. The control unit 301 controls the various compositional elements so as to stop subsequent processing. In this way, the main player 300 stops playback of the sub-content.

When the extraction unit 316 judges that the generated characteristic information is not included on the read blacklist (step S205), the hash unit 315 then reads the blacklist from the information storage unit 309, generates a hash value H=Hash (blacklist) by applying the hash function Hash to the read blacklist, and outputs the generated hash value H to the decryption unit 311 (step S206). The decryption unit 311 receives the bind key from the drive unit 307, receives the hash value H from the hash unit 315; and generates a key by connecting the received hash value H and the received bind key in the stated order. The decryption unit 311 then generates a sub-content key by applying the decryption algorithm D2 to the read encrypted sub-content using the generated key, and outputs the generated sub-content key to the decryption unit 313 (step S207).

The decryption unit 313 receives the sub-content key from the decryption unit 311, generates sub-content by applying the decryption algorithm D1 to the read encrypted sub-content using the received sub-content key, and outputs the generated sub-content to the playback unit 312 (step S208).

The playback unit 312 receives the sub-content, generates a video signal from the received sub-content and outputs the generated video signal to the monitor 351, and also generates an audio signal from the received sub-content and outputs the generated audio signal to the speaker 352 (step S209).

1.10 Operations by the Sub-Player 400 for Playing Back the Sub-Content

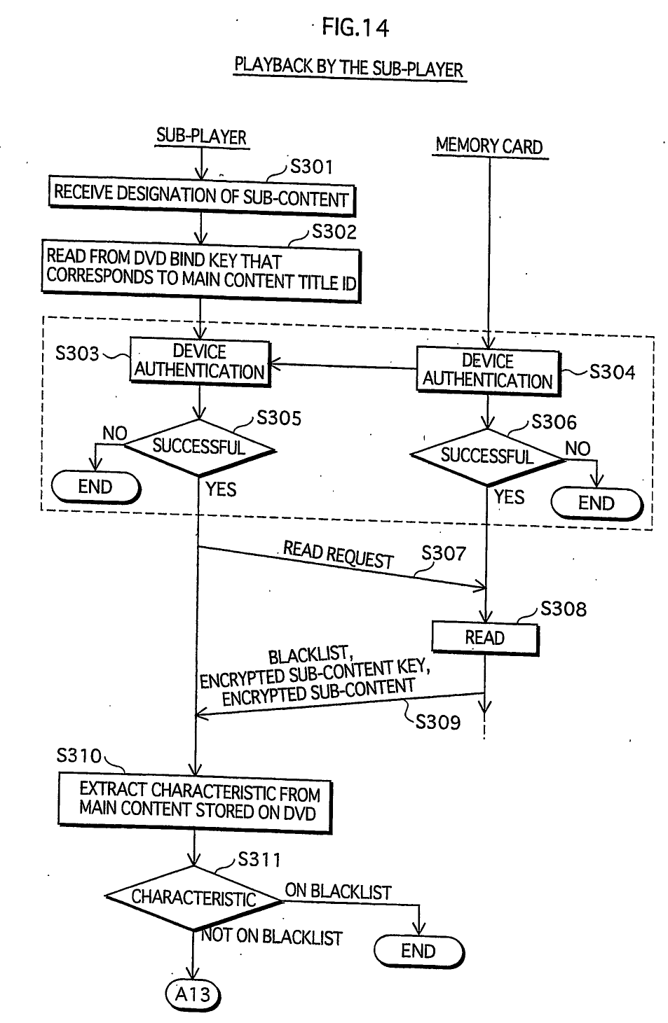

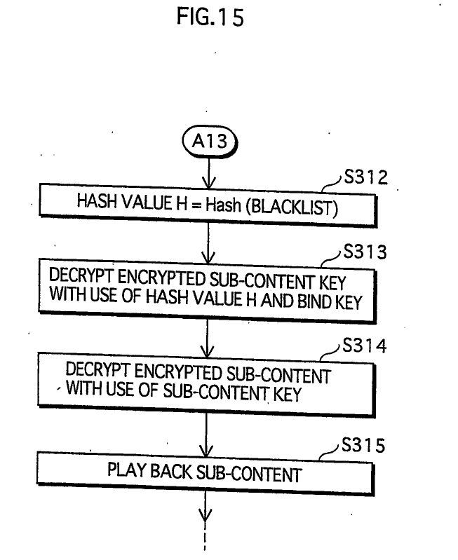

The following describes operations by the sub-player 400 for playing back the sub-content, with use of the flowcharts shown in FIGS. 14 to 15.

The input unit 403 of the sub-player 400 receives a designation from the user of sub-content to be played back, acquires the title ID of the sub-content for which the designation was received, from the memory card 600, and outputs the acquired sub-content title ID to the control unit 401 (step S301).

Next, the control unit 401 generates a main content title ID from the received sub-content title ID, and outputs the generated main content title ID to the drive unit 407. The drive unit 407 receives the title ID from control unit 401, reads the bind key that corresponds to the received title ID from the DVD 500, and outputs the read bind key to the decryption unit 411 (step S302).

Next, the sub-player 400 and the memory card 600 perform mutual device authentication (steps S303 to S304). When mutual device authentication fails (steps S305, S306), the apparatuses stop subsequent processing.

When mutual device authentication succeeds (steps S305, S306), the input/output unit 410 outputs a request to the memory card 600 to read the blacklist, the encrypted sub-content key and the encrypted sub-content (step S307).

The input/output unit 601 of the memory card 600 receives the read request (step S307), reads the blacklist, the encrypted sub-content key and the encrypted sub-content from the information storage unit 603, and outputs the read blacklist, encrypted sub-content key and encrypted sub-content to the sub-player 400. The input/output unit 410 receives the blacklist, the encrypted sub-content key and the encrypted sub-content (step S309).

The extraction unit 416 reads the encrypted main content from the DVD 500 via the drive unit 407, generates main content by decrypting the encrypted main content, and extracts a characteristic from the generated main content to generate characteristic information (step S310). The extraction unit 416 receives the blacklist from the input/output unit 410, and judges whether the generated characteristic information is included on the blacklist. When the generated characteristic information is included on the blacklist (step S311), the extraction unit 416 considers the DVD to be a pirate disk, and outputs an instruction to the control unit 401 to stop subsequent processing. The control unit 401 controls the various compositional elements so as to stop subsequent processing. In this way, the sub-player 400 stops playback of the sub-content.

When the extraction unit 416 judges that the generated characteristic information is not included on the read blacklist (step S311), the hash unit 415 then receives the blacklist from the input/output unit 410, generates a hash value H=Hash (blacklist) by applying the hash function Hash to the received blacklist, and outputs the generated hash value H to the decryption unit 411 (step S312). The decryption unit 411 receives the bind key from the drive unit 407, receives the hash value H from the hash unit 415, and generates a key by connecting the received hash value H and the received bind key in the stated order. The decryption unit 411 then generates a sub-content key by applying the decryption algorithm D2 to the read encrypted sub-content using the generated key, and outputs the generated sub-content key to the decryption unit 413 (step S313).

The decryption unit 413 receives the sub-content key from the decryption unit 411, generates sub-content by applying the decryption algorithm D1 to the read encrypted sub-content using the received sub-content key, and outputs the generated sub-content to the playback unit 412 (step S314).

The playback unit 412 receives the sub-content, generates a video signal from the received sub-content and outputs the generated video signal to the monitor 417, and also generates an audio signal from the received sub-content and outputs the generated audio signal to the speaker 451 (step S315).

1.12 Operations by the Sub-Player 400 and the Memory Card 600 for Mutual Authentication

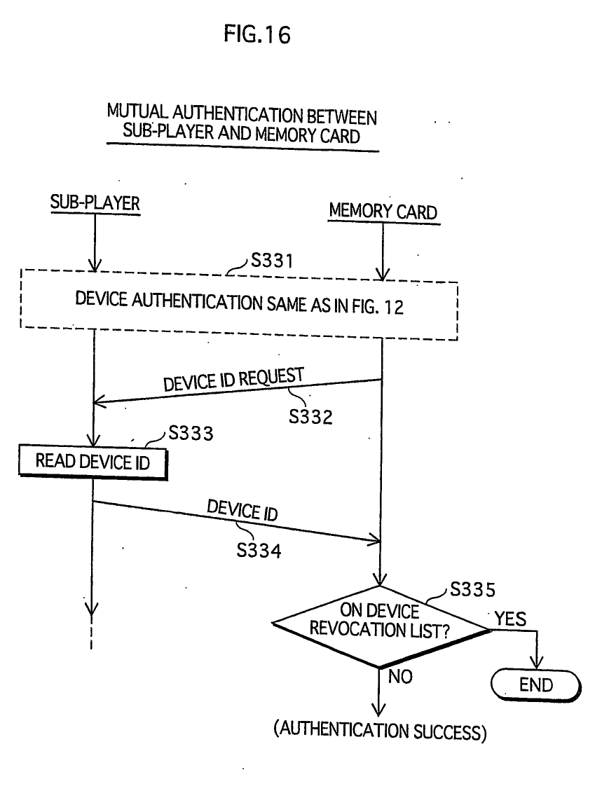

The following describes operations by the sub-player 400 and the memory card 600 for mutual authentication, with use of the flowchart in FIG. 16. Note that the operations for mutual authentication described here are details of operations at steps S303 to S306 in the flowchart in FIG. 14.

The authentication unit 414 of the sub-player 400 performs transmission and reception of information for mutual authentication with the authentication unit 602 via the input/output unit 410 and the input/output unit 601 of the memory card 600. Likewise, the authentication unit 602 of the memory card 600 performs transmission and reception of information for mutual authentication with the authentication unit 414 via the input/output unit 600 and the input/output unit 410 of the sub-player 400. Note that in the following, information is simply described as being transmitted/received between the authentication unit 414 and the authentication unit 602, and mention of the paths therebetween is omitted.

The authentication unit 414 and the authentication unit 602 perform device authentication using the same method as the mutual authentication shown in the flowchart in FIG. 12 (step S331).

When mutual device authentication succeeds, the authentication unit 602 requests a device ID from the authentication unit 414 (step S332).

The authentication unit 414 receives the request (step S332), reads the device ID from the ID storage unit 418 (step S333), and outputs the read device ID to the authentication unit 602 (step S334).

The authentication unit 602 receives the device ID (step S334), judges whether the received device ID is included on the device revocation list 625 stored in the information storage unit 603, and when the device ID is not included (step S335), considers authentication to have succeeded.

When the device ID is included (step S335), the authentication unit 602 considers the sub-player 400 to be a revoked apparatus, and the controls the input/output unit 601 so as to stop subsequent processing.

### 2. Second Embodiment

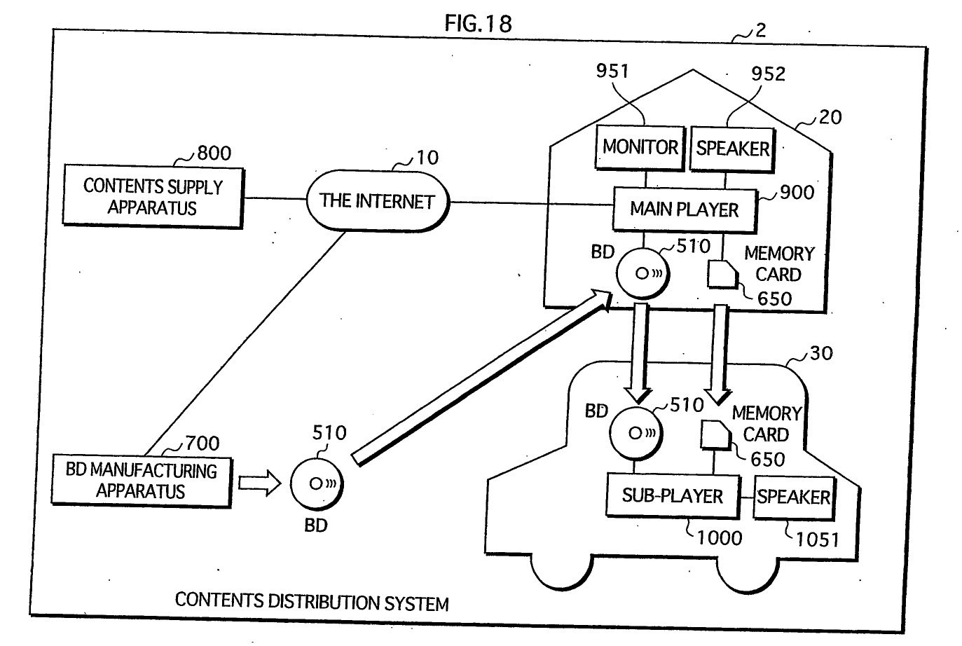

As shown in FIG. 18, a contents distribution system 2 is composed of a BD manufacturing apparatus 700, a contents supply apparatus 800 and a main player 900.

The BD manufacturing apparatus 700, which is owned by a BD (Blu-ray Disc) manufacturer, writes main content to a BD. Here, the BD is a ROM-type recording medium to which information can be written only once. Furthermore, an example of main content is movie information composed of digital video data and digital audio data. A BD 510 to which main content has been written is sold by a seller. A user purchases, and thus owns, the BD 510.

The contents supply apparatus 800 is owned by a sub-contents supplier. Sub-content is content that relates to the main content, and an example of sub-content is subtitle information.

The main player 900 is set in the house in which the user lives. According to user operations, the main player 900 acquires sub-content, and performs linked playback of main content and sub-content.

A manufacturer who is the operator of the BD manufacturing apparatus 700 judges whether or not the sub-content can be authorized as sub-content of the main content.

The contents supplier is able to distribute the sub-content to users if authorized by the manufacturer.

The following describes the structure of each apparatus.

2.1 Structure of the Contents Supply Apparatus 800

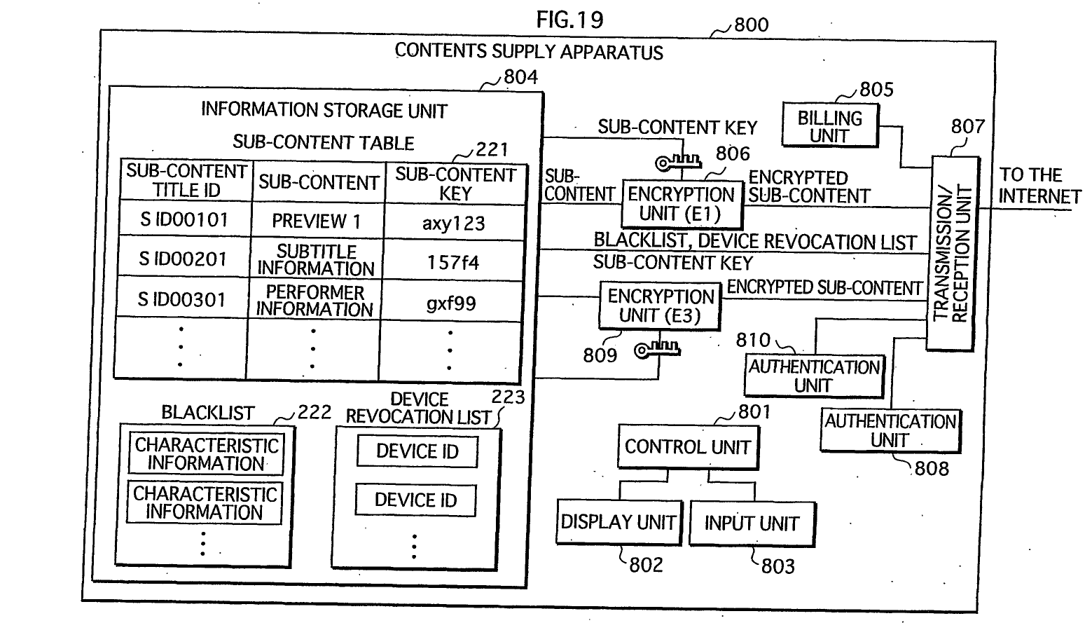

As shown in FIG. 19, the contents supply apparatus 800 is composed of a control unit 801, a display unit 802, an input unit 803, an information storage unit 804, a billing unit 805, an encryption unit 806, a transmission/reception unit 807, an authentication unit 808, an encryption unit 809 and an authentication unit 810.

The contents supply apparatus 800 is a computer system similar to the contents supply apparatus 200. The contents supply apparatus 800 achieves its functions by a microprocessor operating according to computer programs.

The display unit 802, the input unit 803, the billing unit 805, the encryption unit 806 and the authentication unit 808 have the same structure as the display unit 202, the input unit 203, the billing unit 205, the encryption unit 206 and the authentication unit 208 of the contents provision apparatus 200.

(1) Information Storage Unit 804

The information storage unit 804 is specifically composed of a hard disk unit, and stores the sub-content table 221, the blacklist 222 and the device revocation list 223, in the same way as the information storage unit 204.

Note that sub-content not authorized by the manufacturer (hereinafter caller “unauthorized sub-content”) does not have a title ID. For this reason, unauthorized sub-content is not stored in the sub-content storage table 221, but is stored in another area of the information storage unit 804.

Note also that when a plurality of unauthorized sub-contents are stored, the unauthorized sub-contents may be stored with identifiers for identifying each sub-content in the contents supply apparatus 800.

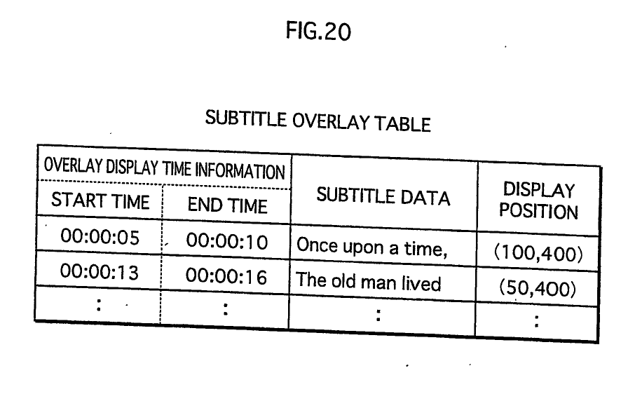

Here, as one example of sub-content, subtitle information indicated by a sub-content title ID SID00201 is a subtitle overlay program for displaying subtitle data overlaid on a screen of main content, and includes a subtitle overlay table such as shown in FIG. 20. The subtitle overlay table is composed of overlay display times, subtitle data and display positions in correspondence with each other.

Each overlay display time information is composed of a start time and an end time. The start time indicates a time when overlay display starts, and the end time indicates a time when overlay display ends.

Subtitle data is subtitle data that is to be displayed overlaid during the time indicated by the corresponding overlay display time information.

Display position indicates a position where the corresponding subtitle data is to be displayed overlaid.

The subtitle overlay program counts playback time from 0 upon the main content being played back, and when the counted playback time is between a start time and an end time, displays the corresponding subtitle information overlaid in the corresponding display position.

In this way, linked playback of the sub-content and the main content is performed.

The information storage unit 804 has an encryption key K1 (not illustrated).

Furthermore, the information storage unit 804 has an area for storing signature data and a public key certificate of the BD manufacturing apparatus 700 for each sub-content in correspondence with the corresponding sub-content information. Note that the signature data is generated by the BD manufacturing apparatus 700 from the sub-content and the title ID of the main content on which the sub-content is based, when the sub-content is authorized by the manufacturer.

(2) Control Unit 801

On receiving, via the input unit 803, input that indicates transmission of a main content title ID and unauthorized sub-content to the BD manufacturing apparatus 700, the control unit 801 outputs the sub-content to the encryption unit 809, and controls the encryption unit 809 so that the encryption unit 809 encrypts the sub-content. Note that the contents supply apparatus 800 may read the main content title ID from the BD if the contents supply apparatus 800 has a function of reading data from a BD.

Furthermore, the control unit 801 controls the transmission/reception unit 807 so that the transmission/reception unit 807 transmits the encrypted sub-content and the main content title ID to the BD manufacturing apparatus 700.

On receiving, via the transmission/reception unit 807, a sub-content title ID, signature data and a public key certificate from the BD manufacturing apparatus 700, the control unit 801 writes the sub-content title ID to the sub-content table 221, and writes the signature data and the public key certificate in correspondence with the sub-content information.

On receiving a user ID, a sub-content acquisition request and a main content title ID from the main player 900 via the Internet 10 and the transmission/reception unit 807, the control unit 801 performs processing as described in the first embodiment.

(3) Encryption Unit 809

The encryption unit 809 reads the encryption key K1 from the information storage unit 804. On receiving sub-content from the control unit 801, the encryption unit 809 generates encrypted sub-content by applying an encryption algorithm E3 to the sub-content using the encryption key K1. Here, as one example, the encryption algorithm E3 is DES. The encryption unit 809 outputs the generated encrypted sub-content to the transmission/reception unit 807.

(4) Authentication Unit 810

The authentication unit 810 performs mutual authentication with an authentication unit 710 of the BD manufacturing apparatus 700.

When the authentication unit 810 fails to authenticate the opponent, the contents supply apparatus 800 stops sub-content transmission processing.

When the authentication unit 810 succeeds in authenticating the opponent, the contents supply apparatus 800 transmits the sub-content to the BD manufacturing apparatus 700.

(5) Transmission/Reception Unit 807

Based on control by the control unit 801, the transmission/reception unit 807 transmits the encrypted sub-content and the main content title ID via the Internet 10 to the BD manufacturing apparatus 700. Furthermore, based on control by the control unit 801, the transmission/reception unit 807 transmits the sub-content title ID, the encrypted sub-content, the sub-content key, the signature data, the public key certificate, the blacklist and the device revocation list via the Internet 10 to the main player 900.

2.2 Structure of the BD Manufacturing Apparatus 700

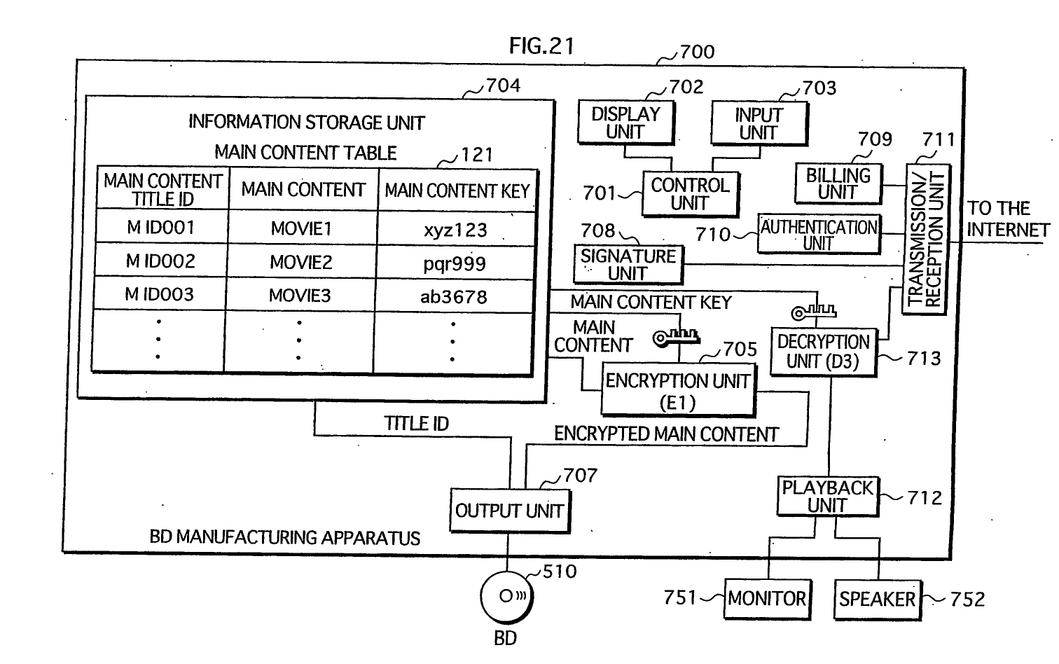

As shown in FIG. 21, the BD manufacturing apparatus 700 is composed of a control unit 701, a display unit 702, an input unit 703, an information storage unit 704, an encryption unit 705, an output unit 707, a signature unit 708, a billing unit 709, the authentication unit 710, a transmission/reception unit 711, a playback unit 712 and a decryption unit 713. A monitor 751 and a speaker 752 are connected to the playback unit 712.

The BD manufacturing apparatus 700 is a computer system similar to the DVD manufacturing apparatus 100. The BD manufacturing apparatus 700 achieves its functions by a microprocessor operating according to computer programs.

The information storage unit 704, the encryption unit 705 and the output unit 707 have the same structure as the information storage unit 104, the encryption unit 105 and the output unit 107 of the DVD manufacturing apparatus 100.

(1) Control Unit 701, Display Unit 702 and Input Unit 703

The control unit 701 receives from an operator via the input unit 703 an operation to write main content to a BD, and a main content title ID. The control unit 701 controls the encryption unit 705 and the output unit 707 based on the received instruction information and the main content title ID.

The display unit 702 displays various information according to control by the control unit 701.

On receiving a device authentication request via the transmission/reception apparatus 711 from the contents supply apparatus 800, the control unit 701 controls the authentication unit 710 so that the authentication unit 710 performs mutual device authentication with the contents supply apparatus 800.

When authentication by the authentication unit 710 succeeds, the control unit 701 receives the main content title ID and the encrypted sub-content.

The control unit 701 has the display unit 702 perform display indicating that encrypted sub-content has been received. On the input unit 703 receiving an operation indicating linked playback of the sub-content from the operator, the control unit 701 controls the decryption unit 713 so that the decryption unit 713 decrypts the encrypted sub-content, and controls the playback unit 712 so that the playback unit 712 performs linked playback of the main content indicated by the received main content title ID and the decrypted sub-content.

On the input unit 703 receiving an operation indicating applying a signature to the sub-content from the operator, the control unit 701 controls the signature unit 708 so that the signature unit 708 generates signature data. Furthermore, the control unit 701 assigns to the sub-content a proper title ID that is not a duplicate of that of any other sub-content, outputs the assigned sub-content title ID to the billing unit 709, and controls the billing unit 709 so that the billing unit 709 performs billing processing.

The control unit 701 controls the transmission/reception unit 711 so that the transmission/reception unit 711 transmits the sub-content title ID, the signature data and the public key certificate to the contents supply apparatus 800.

(2) Authentication Unit 710

The authentication unit 710 performs mutual device authentication with the authentication unit 810 of the contents supply apparatus 800.

When the authentication unit 710 fails to authenticate the opponent, the BD manufacturing apparatus 700 stops subsequent processing.

When the authentication unit 710 is successful in authenticating the opponent, the BD manufacturing apparatus 700 receives the sub-content from the contents supply apparatus 800.

(3) Decryption Unit 713

The decryption unit 713 reads a decryption key K2 stored in the information storage unit 704. This decryption key K2 is the opposite key to the encryption key K1 held by the information storage unit 804 of the contents supply apparatus 800. The decryption unit 713 decrypts the encrypted su b-content by applying a decryption algorithm D3 to the encrypted sub-content using the decryption key K2, thereby generating sub-content. Here, the decryption algorithm D3 corresponds to the encryption algorithm E3, and is for decrypting a cipher text encrypted according to the encryption algorithm E3.

The decryption unit 713 outputs the generated sub-content to the playback unit 712.

(4) Playback Unit 712

The playback unit 712 receives main content, and plays back the main content by generating a video signal from the received sub-content and outputting the generated video signal to the monitor 751, and also generating an audio signal from the received sub-content and outputting the generated audio signal to the speaker 752. On starting playback of the main content, the playback unit 712 counts playback time starting from 0.

The playback unit 712 receives sub-content, generates subtitle information from the received sub-content, and when the counted playback time matches the start time corresponding to the subtitle data, starts overlay display of the subtitle data. When the counted playback time matches the end time corresponding to the subtitle data, the playback unit 712 ends overlay display of the subtitle data.

(5) Signature Unit 708

The signature unit 708 has a secret key SK.

On receiving a main content title ID and sub-content, the signature unit 708 applies a digital signature algorithm S to the received main content title ID and sub-content, using the secret key SK, thereby generating signature data. Here, as one example, the digital signature algorithm S is an ElGamal signature on a finite field. Since ElGamal signatures are commonly known, a description thereof is omitted.

The signature unit 708 outputs the generated signature data to the transmission/reception unit 711.

(6) Billing Unit 709

On receiving a sub-content title ID from the control unit 701, the billing unit 709 performs processing to bill the sub-contents supplier that created the sub-content for authorization of the sub-content indicated by the received title ID.

(7) Transmission/Reception Unit 711

On receiving signature data, the transmission/reception unit 711, based on control by the control unit 701, reads the public key certificate held by the BD manufacturing apparatus 700, and transmits the sub-content title ID, the signature data and the public key certificate via the Internet 10 to the contents supply apparatus 800.

Here, the public key certificate includes a public key PK that is opposite to the secret key SK used by the signature unit 708 when generating the received signature data. Note that public key certificates are described in detail in Digitaru Shomei to Ango Gijutsu (Digital Signatures and Encryption Techniques), trans. S. Yamada, Pearson Education Japan, and therefore a description thereof is omitted here.

2.3 Structure of the Main Player 900

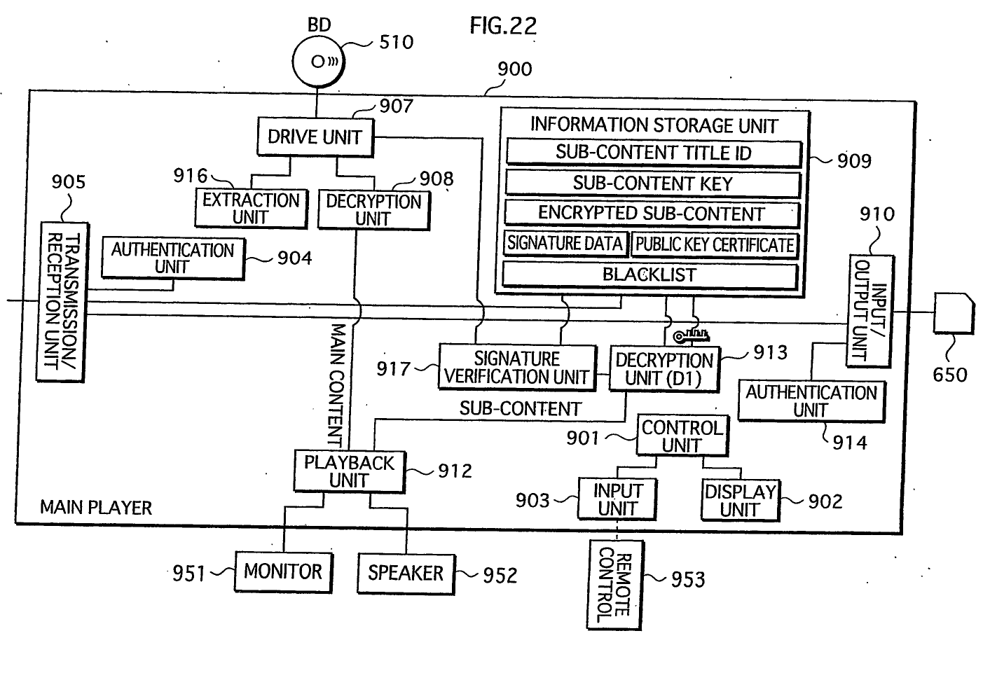

As shown in FIG. 22, the main player 900 is composed of a control unit 901, a display unit 902, an input unit 903, an authentication unit 904, a transmission/reception unit 905, a drive unit 907, a decryption unit 908, an information storage unit 909, an input/output unit 910, a playback unit 912, a decryption unit 913, an authentication unit 914, an extraction unit 916 and a signature verification unit 917. A monitor 951 and a speaker 952 are connected to the playback unit 912. The input unit 903 receives an input signal from the user via a remote control 953.

The main player 900 is a computer system similar to the main player 300. The main player 900 achieves its functions by a microprocessor operating according to computer programs.

The display unit 902, the input unit 903, the authentication 904, the drive unit 907, the authentication unit 914 and the extraction unit 916 have the same structure as the display unit 302, the input unit 303, the authentication unit 304, the drive unit 307, the authentication unit 314 and the extraction unit 316 of the main player 300.

(1) Information Storage Unit 909

The information storage unit 909 is specifically composed of a hard disk unit, and includes a storage area for storing a sub-content title ID, a sub-content key, encrypted sub-content signature data, a public key certificate and a blacklist.

(2) Control Unit 901

The control unit 901 acquires sub-content by performing processing as described in the first embodiment.

When sub-content is to be played back, the control unit 901, on receiving a sub-content title ID from the input unit 903, controls the extraction unit 916 so that the extraction unit 916 extracts a characteristic, and controls the other compositional elements based on the result of the extraction by the extraction unit 916.

(3) Transmission/Reception Unit 905

On receiving a sub-content title ID, an encrypted sub-content key, encrypted sub-content, signature data, a public key certificate, a blacklist and a device revocation list via the Internet 10, the transmission/reception unit 905 writes the sub-content title ID, the encrypted sub-content key, the encrypted sub-content, the signature data, the public key certificate and the blacklist to the information storage unit 909.

Furthermore, the transmission/reception unit 905 outputs the sub-content title ID, the encrypted sub-content key, the encrypted sub-content, the signature data, the public key certificate, the blacklist and the device revocation list via the input/output unit 910 to the mounted memory card 650.

(4) Signature Verification Unit 917

Based on control by the control unit 901, the signature verification unit 917 receives a main content title ID from the drive unit 907, receives sub-content from the decryption unit 913, and reads signature data and the public key certificate from the information storage unit 909. The signature verification unit 917 extracts the public key PK from the public key certificate, applies a signature verification algorithm V to the signature data using the extracted public key PK, and verifies whether or not the certificate data is legal. Here, the signature verification algorithm V is a signature verification algorithm for verifying signature data generated according to the digital signature S.

When the verification by the signature verification unit 917 results in failure, the main player 900 ends the sub-content playback processing. When verification by the signature verification unit 917 results in success, the main player 900 continues playback of the sub-content.

(5) Drive Unit 907

Based on control by the control unit 901, the drive unit 907 reads the main content key and encrypted main content from the BD 510, and outputs the read main content key and encrypted main content to the decryption unit 908.

(6) Decryption Unit 908

The decryption unit 908 receives the encrypted main content and the main content key from the drive unit 907, and decrypts the encrypted content by applying the decryption algorithm D1, thereby generating main content. The decryption unit 908 outputs the generated main content to the playback unit 912.

(7) Decryption Unit 913

Based on control by the control unit 901, the decryption unit 913 reads the sub-content key and encrypted sub-content from the information storage unit 909, generates sub-content by applying the decryption algorithm D1 to the read encrypted sub-content, and outputs the generated sub-content to the signature verification unit 917.

Furthermore, when the result of the verification by the signature verification unit 917 is successful, the decryption unit 913 generates sub-content by decrypting as described, and outputs the generated sub-content to the playback unit 912.

(8) Playback Unit 912

The playback unit 912 performs linked playback of main content and sub-content.

The playback unit 912 receives main content from the decryption unit 908, and plays back the sub-content by generating a video signal from the received sub-content and outputting the generated video signal to the monitor 951, and also generating an audio signal from the received sub-content and outputting the generated audio signal to the speaker 952. On starting playback of the main content, the playback unit 912 counts playback time starting from 0.

Furthermore, the playback unit 912 receives sub-content from the decryption unit 913, generates subtitle data from the received sub-content, and, when the counted playback time corresponds to a time between the start time and end time corresponding to the subtitle data, displays the subtitle data overlaid in the corresponding display position.

2.4 Structure of the Memory Card 650

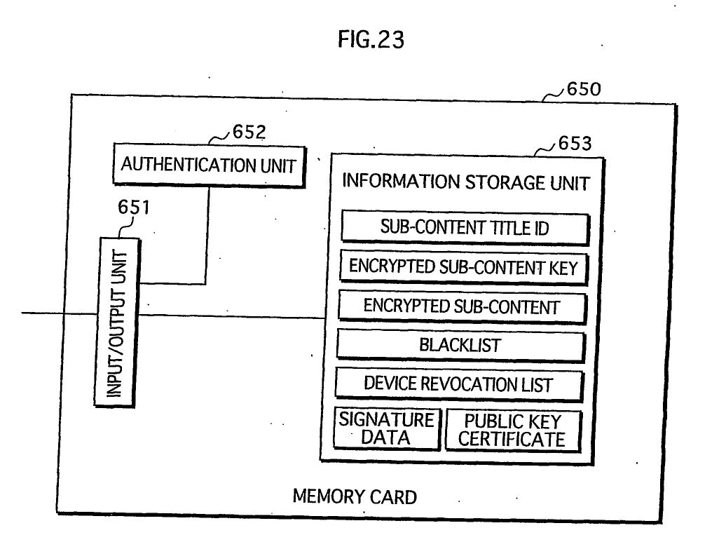

As shown in FIG. 23, the memory card 650 is composed of an input/output unit 651, an authentication unit 652, and an information storage unit 653.

The memory card 650 is a computer system similar to the memory card 600. The memory card 650 achieves its functions by a microprocessor operating according to computer programs.

The input/output unit 651 and the authentication unit 652 have the same structure as the input/output unit 601 and the authentication unit 602 of the memory card 600.

(1) Information Storage Unit 653

The information storage unit 653 has areas for storing a sub-content title ID, a sub-content key, encrypted sub-content, signature data, a public key certificate, a blacklist and a device revocation list.

2.5 Structure of the Sub-Player 1000

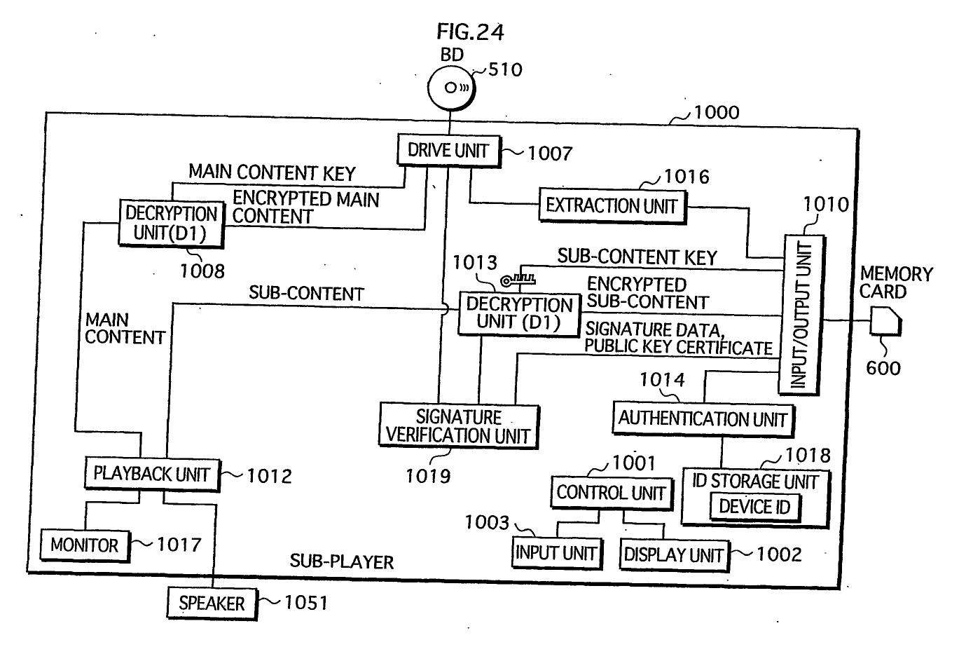

As shown in FIG. 24, the sub-player 1000 is composed of a control unit 1001, a display unit 1002, an input unit 1003, a drive unit 1007, a decryption unit 1008, an input/output unit 1010, a playback unit 1012, a decryption unit 1013, an authentication unit 1014, an extraction unit 1016, a monitor 1017, an ID storage unit 1018 and a signature verification unit 1019.

The sub-player 1000 is a computer system similar to the sub-player 400. The sub-player 1000 achieves its functions by a microprocessor operating according to computer programs.

(1) Signature Verification Unit 1019

Based on control by the control unit 1001, the signature verification 1019 reads sub-content, signature data and a public key certificate via the input/output unit 1010 from the memory card 650, and receives a main content title ID from the drive unit 1007. The signature verification unit 1019 extracts the public key from the public key certificate, applies the signature verification algorithm V to the signature data with use of the extracted public key PK, and verifies whether or not the signature data is correct.

When verification results in failure, the sub-player 1000 ends sub-content playback processing. When verification results in success, the sub-player 1000 continues sub-content playback processing.

(2) Playback Unit 1012

The playback unit 1012 performs linked playback of the main content and sub-content based on the counted playback time.

2.6 Operations by the Contents Supply Apparatus 800

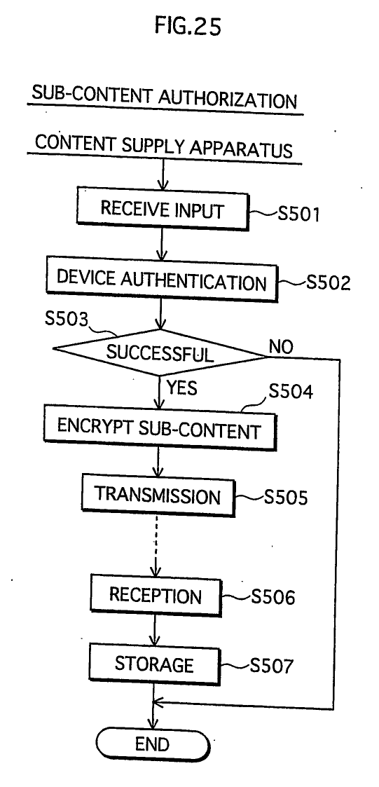

Operations by the contents supply apparatus 800 for receiving permission for sub-content from the manufacturer are described with reference to FIG. 25.

According to an input by a user, the input unit 803 receives input that indicates transmission of a main content title ID and unauthorized sub-content to the BD manufacturing apparatus 700 (step S501).

The authentication unit 810 transmits an authentication request to the BD manufacturing apparatus 700, and performs mutual device authentication with the authentication unit 810 (step S502).

When device authentication fails (step S503), the contents supply apparatus 800 stops subsequent processing. When device authentication is successful (step S503), the encryption unit 809 of the contents supply apparatus 800 reads the unauthorized sub-content from the information storage unit 804, and generates encrypted sub-content by encrypting the read sub-content with use of the encryption key K1 (step S504). The encryption unit 809 outputs the main content title ID of which input was received and the generated encrypted sub-content to the transmission/reception unit 807. The transmission/reception unit 807 transmits the main content title ID and the encrypted sub-content via the Internet 10 to the BD manufacturing apparatus 700 (step S505).

On receiving the sub-content title ID, the signature data and the public key certificate via the transmission/reception unit 807 (S506), the control unit 801 writes the sub-content title ID, the sub-content and the sub-content key to the sub-content table 221 as sub-content information, and writes received signature data and public key certificate in correspondence with the sub-content information (step S507).

2.7 Operations by the BD Manufacturing Apparatus 700

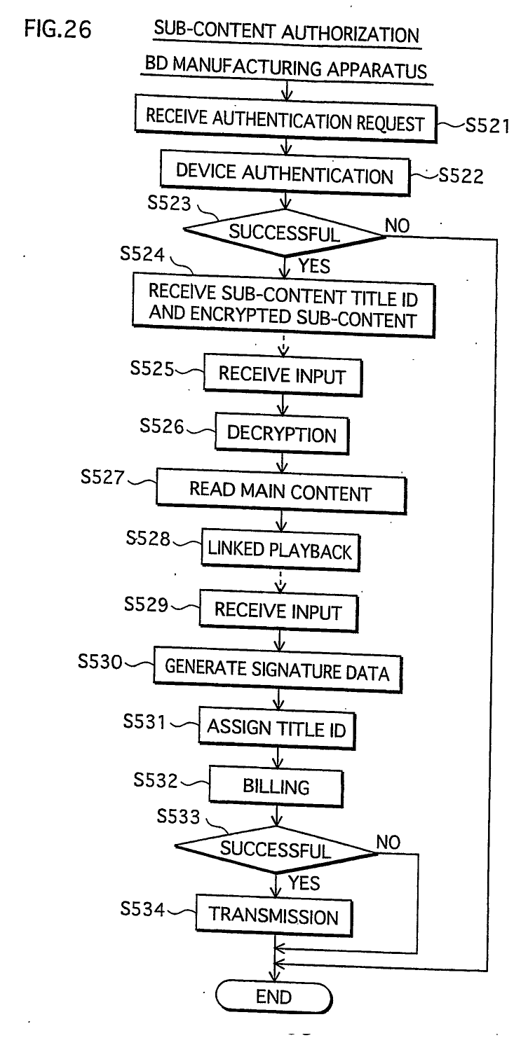

Operations by the BD manufacturing apparatus 700 when authorizing encrypted sub-content are described with use of FIG. 26.

On receiving an authentication request from the contents supply apparatus 800 via the transmission/reception unit 711 (step S521), the authentication unit 710 performs mutual device authentication with the authentication unit 810 (step S522). When device authentication fails (step S523), the contents supply apparatus 800 stops subsequent processing. When device authentication succeeds (step S523), the control unit 701 receives a main content title ID and encrypted sub-content from the contents supply apparatus 800 (step S524), and the display unit 702 performs display so as to indicate that the main content title ID and the encrypted sub-content have been received.

On receiving input indicating playback of the received encrypted content from the input unit 703 (step S525), the decryption unit 713 generates sub-content by decrypting the received encrypted sub-content (step S526), and outputs the generated sub-content to the playback unit 712. The control unit 701 outputs the received main content title ID to the playback unit 712, and the playback unit 712 reads the main content from the information storage unit 704 (step S527) and performs linked playback of the read main content and the received sub-content (step S528).

On receiving input indicating applying a signature to sub-content from the input unit 703 (step S529), the signature unit 708 generates signature data with respect to the main content title ID and the sub-content (step S530). The signature unit 708 outputs the generated signature data to the transmission/reception unit 711. Furthermore, the control unit 701 assigns a title ID to the authorized sub-content (step S531), and the billing unit 709 bills the sub-contents supplier (step S532). When billing fails (step S533: NO), the BD manufacturing apparatus 700 stops subsequent processing.

When billing is successful (step S533: YES), the transmission/reception unit 711 reads the public key certificate, and transmits the read public key certificate, and the received signature data and sub-content title ID to the contents supply apparatus 800 (step 534).

2.8 Operations by the Main Player 900

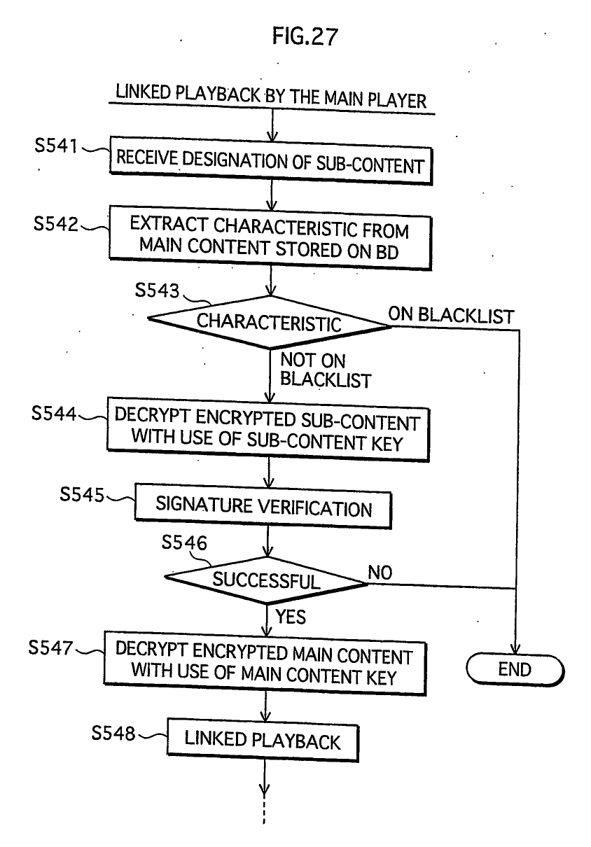

Operations by the main player 900 when performing linked playback of main content and sub-content are described with use of FIG. 27.

The input unit 903 receives, from the user, designation of sub-content to be played back (step S541), acquires the title ID of the sub-content of which the designation was received, and outputs the acquired sub-content title ID to the control unit 901.

The control unit 901 controls the compositional elements so as to perform linked playback of the sub-content and main content indicated by the received sub-content title ID.

The drive unit 907 reads the encrypted main content, and outputs the read encrypted main content to the extraction unit 916.

The extraction unit 916 extracts the characteristic information from the received main content (step S542), reads the blacklist from the information storage unit 909, and judges whether or not the generated characteristic information is included in the read blacklist (step S543). When the extraction unit 916 judges that the characteristic information is included in the read blacklist, the BD 510 is presumed to be a pirated disk, and the main player 900 stops subsequent processing.

When the extraction unit 916 judges that the characteristic information is not included in the read blacklist (step S543), the drive unit 907 reads the main content key and the encrypted main content, and outputs the read main content key and encrypted content to the decryption unit 908.

When the characteristic information is not included in the blacklist, the decryption unit 913 reads the sub-content key and the encrypted sub-content from the information storage unit 909, and generates sub-content by decrypting the encrypted sub-content with use of the sub-content key (step S544). The decryption unit 913 then outputs the generated sub-content to the signature verification unit 917.

Next, the signature verification unit 917 receives the main content title ID from the drive unit 907, receives the sub-content from the decryption unit 913, and reads the signature data and the public key certificate from the information storage unit 909. The signature verification unit 917 extracts the public key PK from the public key certificate, and verifies the signature data with use of the signature data (step S545). When verification results in failure (step S546), the main player 900 stops subsequent processing. When verification results in success (step S546), the decryption unit 913 outputs the generated sub-content to the playback unit 912.

The decryption unit 908 receives the main content key and the encrypted main content, generates main content by decrypting the encrypted content (step S547), and outputs the generated main content to the playback unit 912.

The playback unit 912 performs linked playback of the main content and the sub-content (step S548).

2.7 Operations by the Sub-Player 1000,

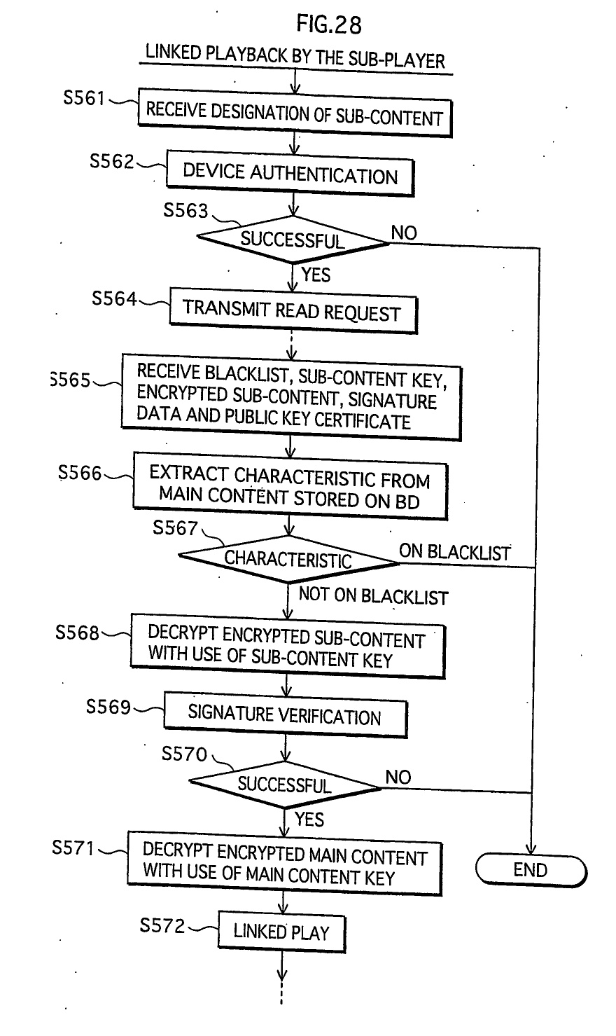

Operations by the sub-player 1000 when playing back sub-content stored on the memory card 650 are described with use of FIG. 28.

The input unit 1003 receives a designation of sub-content to be played from the user (step S561), acquires from the memory card 650 the title ID of the sub-content for which the designation was received, and outputs the acquired sub-content title ID to the control unit 1001.

The control unit 1001 controls the compositional elements so as to perform linked playback of the sub-content and main content indicated by the received sub-content title ID.

The authentication unit 1014 performs mutual device authentication with the memory card 650 (step S562). When device authentication fails (step S563), the sub-player 1000 stops subsequent processing.

When device authentication is successful (step S563), the input/output unit 1010 outputs a read request to the memory card 650 to read the blacklist, the sub-content key, the encrypted sub-content, the signature data, and the public key certificate (step S564).

The input/output unit 1010 receives the blacklist, the sub-content key, the encrypted sub-content, the signature data and the public key certificate (step S565).

The drive unit 1007 reads the encrypted main content indicated by the received title ID, and outputs the encrypted main content to the extraction unit 1016.

The extraction unit 1016 extracts characteristic information from the received main content (step S566), and judges whether or not the extracted characteristic information is included in the read blacklist (step S567). When the characteristic information is included, the sub-player 1000 presumes the BD 510 to be a pirated disc, and stops subsequent processing.

When the extraction unit 1016 judges that the extracted characteristic information is not included in the read blacklist, the drive unit 1007 reads the main content key and the encrypted main content, and outputs the read main content key and encrypted main content to the decryption unit 1008.

The decryption unit 1013 receives the sub-content key and encrypted sub-content from the input/output unit 1010, generates sub-content by decrypting the encrypted sub-content with use of the sub-content key (step S568), and outputs the generated sub-content to the signature verification unit 1019.

Next, the signature verification unit 1019 receives the title ID of the main content of the BD 510 from the drive unit 1007, receives the sub-content from the decryption unit 1013, and receives the signature data and the public key certificate from input/output unit 1010. The signature verification unit 1019 extracts the public key PK from the public key certificate, and verifies the signature data with use of the extracted key (step S569). When verification results in failure (step S570), the sub-player 1000 stops subsequent processing. When verification by the signature verification unit 1019 results in success (step S570), the decryption unit 1013 outputs the generated sub-content to the playback unit 1012.

Furthermore, when the result of the verification by the signature verification unit 1019 is successful (step S570), the decryption unit 1008 generates main content by decrypting the encrypted main content with use of the main content key (step S571), and outputs the generated main content to the playback unit 912.

The playback unit 912 performs linked playback of the main content and the sub-content (step S572).

3. Modifications

Note that although the present invention has been described based on the above embodiments, the present invention is not limited to the embodiments. The following cases are included in the present invention.

(1) A user legally purchases, and thus possesses, a DVD on which a movie “Galaxy Wars: The Birth of the Galaxy Allies” is recorded as the main content. The main player acquires according to user instruction a short movie “Galaxy Wars: The Secret Story of the Birth of the Galaxy Allies”, which is sub-content of the main content “Galaxy Wars: The Birth of the Galaxy Allies”. The main player then encrypts the sub-content and writes the encrypted sub-content to the memory card, as described in the above embodiment.

The main player plays back the encrypted sub-content written to the memory card, according to user instruction, only when both the DVD to which “Galaxy Wars: The Birth of the Galaxy Allies” is written and the memory card to which the sub-content is written are mounted in the main player, as described in the above embodiment. This enables the user to playback and enjoy the short movie “Galaxy Wars: The Secret Story of the Birth of the Galaxy Allies”. This applies to the sub-player also.

Here, the user rents DVDs on which a movies “Galaxy Wars: The Takeover” and “Galaxy Wars: The Demise of the Allies” are respectively recorded as main content. These movies are sequels of “Galaxy Wars: The Birth of the Allies”.

When the user has mounted both the memory card on which the encrypted sub content is recorded and the rented DVD on which “Galaxy Wars: The Demise of the Allies” is recorded in the main player, the main player plays back the encrypted-sub-content written to the memory card, according to user instruction. In this case also, the user is able to playback and enjoy the short movie “Galaxy Wars: The Secret Story of the Birth of the Galaxy Allies”. This also applies to the sub-player.

In this way, as described in the above embodiment, when the user legally possesses, by legally purchasing or the like, a DVD on which main content A is recorded, sub-content B that relates to the main content A can be acquired by the main player from the contents supply apparatus, and written to the memory card.

Next, suppose that the user acquires DVDs on which main content C and D, which relate to main content A, are respectively recorded, by a legal method other than purchasing, such as rental. Here, sub-content is chargeable, and when the memory card and the DVD on which the main content C is recorded are both mounted in the main player, the main player is able to play back the sub-content recorded on the memory card. This is the same when both the memory card and the DVD on which the main content D is recorded are mounted in the main player. Furthermore, this also applies to the sub-player.

The following describes a specific structure for realizing the above-described modification.

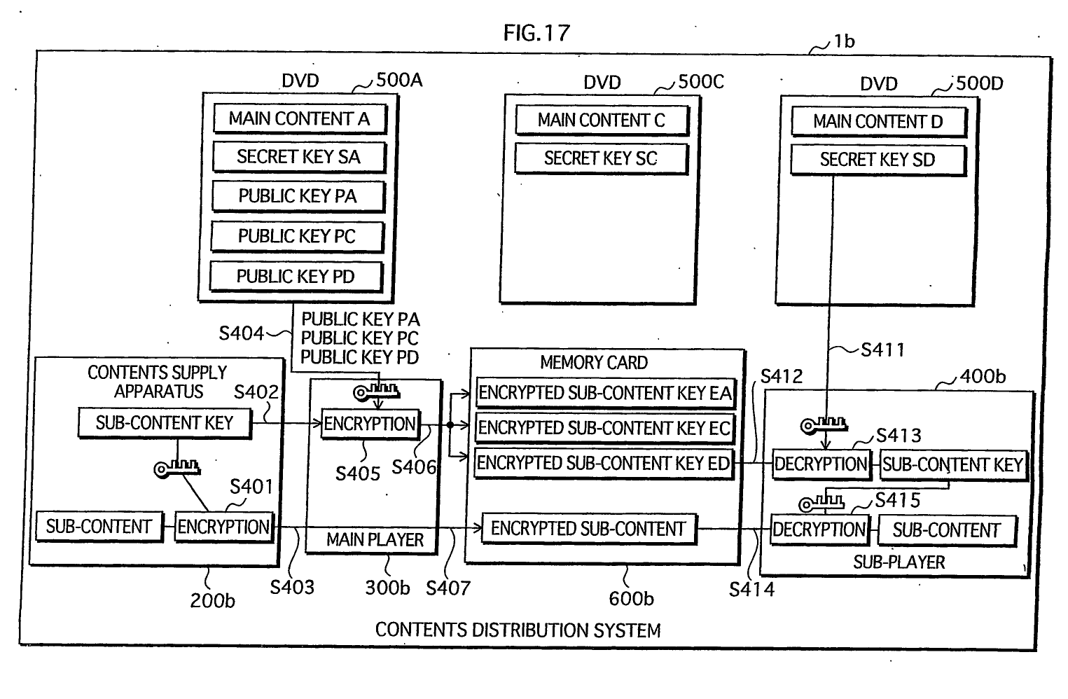

A contents distribution system 1b has a similar structure to the contents distribution system 1, but instead of the contents supply apparatus 200, the main player 300 and the sub-player 400, the contents distribution system 1b includes a contents supply apparatus 200b, a main player 300b and a sub-player 400b, as shown in FIG. 17.

The user purchases a DVD 500A legally. In addition, the user rents a DVD 500C and a DVD 500D.

Main content A, a secret key SA, a public key PA, a public key PC and a public key PD are recorded on the DVD 500A. Here, the secret key SA is a secret key that corresponds to the main content A, and the public key PA is a public key that corresponds to the main content A. Furthermore, the public key PC and the public key PD are public keys that correspond respectively to main content C and main content D that are described later.

The main content C and a secret key SC are recorded on the DVD 500C. The main content C is content that relates to the main content A. The secret key SC is a secret key that corresponds to the main content C.

The main content D and a secret key SD are recorded on the DVD 500D. The main content D is content that relates to the main content A. The secret key SD is a secret key that corresponds to the main content D.

The secret keys and the public keys comply with the public key encryption method.

The public key PA is used for encrypting plaintext. The secret key SA corresponds to the public key PA, and is used for decrypting a ciphertext that was generated using the public key PA.

Furthermore, the public key PC is used for encrypting plaintext. The secret key SC corresponds to the public key PC, and is used for decrypting a ciphertext that was generated using the public key PC.

In addition, the public key PD is used for encrypting plaintext. The secret key SD corresponds to the public key PD, and is used for decrypting a ciphertext that was generated using the public key PD.

The user mounts the DVD 500A and the memory card 600 in the main player 300b, and instructs the main player 300b to acquire sub-content that relates to the main content A from the contents supply apparatus 200b. Information has not yet been recorded on the memory card 600b at this point.

The main player 300b outputs an instruction to the contents supply apparatus 200b to acquire sub-content. The contents supply apparatus 200b generates encrypted sub-content by encrypting the sub-content using the sub-content key (step S401). Next, the contents supply apparatus 200b supplies the main player 300b with the sub-content key (step S402), and supplies the main player 300b with the encrypted sub-content (step S403).

The main player 300b acquires the sub-content key from the contents supply apparatus 200b (step S402), and acquires the encrypted sub-content from the contents supply apparatus 200b (step S403). Next, the main player 300b reads the public key PA, the public key PC and the public key PD from the DVD 500A (step S404), and generates an encrypted sub-content key EA, an encrypted sub-content key EC and an encrypted sub-content key ED by encrypting the received sub-content key respectively using the read public key PA, public key PC and public key PD (step S405). The main player 300b writes the generated encrypted sub-content key EA, encrypted sub-content key EC and encrypted sub-content key ED to the memory card 600b (step S406), and then writes the received encrypted sub-content to the memory card 600b (step S407).

In this way, the encrypted sub-content key EA, the encrypted sub-content key EC, the encrypted sub-content key ED, and the encrypted sub-content are recorded on the memory card 600b as shown in FIG. 17.

Next, the user mounts both the memory card 600b on which the encrypted sub-content key EA, the encrypted sub-content key EC, the encrypted sub-content key ED and the encrypted sub-content are recorded and the DVD 500D in the sub-player 400b, and instructs the sub-player to play back the encrypted sub-content that is recorded on memory card 600b.

The sub-player 400b reads the secret key SD from the DVD 500 (step S411), reads the encrypted sub-content key ED from memory card 600b (step S412), and generates a sub-content key by decrypting the encrypted sub-content key ED using the read secret key SD (step S413). Next, the sub-player 400b reads the encrypted sub-content from the memory card 600b (step S414), and generates sub-content by decrypting the read encrypted sub-content using the generated sub-content key (step S415). Next, the sub-player 400b plays back the sub-content.

In this way, the sub-player 400b is able to decrypt and play back encrypted sub-content recorded on the memory card 600b when both the memory card 600b and the DVD 500D are mounted. The main player 300b plays back in the same way.

Furthermore, the same applies to when both the memory card 600b and the DVD 500A are mounted in the sub-player 400b. Furthermore, the same applies to when both the memory card 600b and the DVD 500C are mounted in the sub-player 400b. Furthermore, the same applies to the sub-player 300b.

(2) A disk ID that uniquely identifies the DVD 500 may be recorded on the DVD 500. In this case, when the main player 300 requests sub-content from the contents supply apparatus 200, the main player 300 reads the disk ID from the DVD 500, and transmits the read disk ID to the contents supply apparatus 200. When supplying the main player 300 with the sub-contents, the contents supply apparatus 200 may store the received disk ID and the sub-content in correspondence.

The contents supply apparatus 200 may have a structure by which when it next receives a request for sub-content from the contents supply apparatus 200, it does not permit supply of the sub-content of the received combination of title ID and disk ID. This prevents sub-content being supplied in duplicate.

Furthermore, it is also possible for the supplier of the sub-content to request separate payment from the user for the sub-content in the case of a same combination of title ID and disk ID.

(3) The sub-player 400 may have an internal storage unit such as a hard disk, read encrypted sub-content stored on the memory card 600, and store the read encrypted sub-content in the storage unit.

(4) The main player 300 may read a bind key from the DVD 500 and store the read bind key internally. Here, the main player 300 encrypts the sub-content key with use of the internally-stored bind key. Furthermore, when playing back sub-content, the main player 300 may decrypt encrypted content with use of the internally-stored bind key. This also applies to the sub-player 400.

(5) In the above-described embodiment, the main player 300 receives the sub-content and the blacklist, and writes the received sub-content and blacklist to the information storage unit 309, or writes the received sub-content and blacklist to the memory card 600.

Here, when the main player 300 next receives another sub-content and another blacklist, the main player 300 may write the received sub-content to the information storage unit 309, and write the received blacklist over the blacklist that is already being stored in the information storage unit 309. Alternatively, the main player may write the received sub-content to the memory card 600, and write the received blacklist over the blacklist that is already being stored in the information storage unit 309.

In this way, the main player 300 and the memory card 600 store only the most recent of the blacklists that are transmitted.

(6) The following is a possible structure for when the main player 300 acquires sub-content from the contents supply apparatus 200.

When the contents supply apparatus 200 and the main player 300 perform mutual device authentication according the respective authentication unit 208 and authentication unit 304, they share a session key Kses. Specifically, in the mutual authentication process between the contents supply apparatus 200 and the main player 300 shown in FIG. 12, the authentication unit 208 and the authentication unit 304 in the contents supply apparatus 200 and the main player 300, respectively, calculate the session key Kses using the following expression.
Session key Kses=E6(R1(+)R2)

Here, R1 and R2 are random numbers acquired by the contents supply apparatus 200 and the main player 300 in the mutual authentication process shown in FIG. 12.

Furthermore, (+) is an operator that shows an exclusive OR.

Furthermore, Y=E6 (X) shows ciphertext Y acquired by applying an encryption algorithm E6 to plaintext X. Here, the encryption algorithm E6 is, for example, DES encryption.

Next, the main player 300 generates an encrypted bind key by encrypting the bind key read from the DVD 500 using the session key Kses, and transmits the encrypted bind key to the contents supply apparatus 200.

The contents supply apparatus 200 receives the encrypted bind key, and generates a bind key by decrypting the encrypted bind key using the session key Kses.

Next, the contents supply apparatus 200 (a) generates an encrypted sub-content key by encrypting the sub-content with use of the bind key, and then generates a double-encrypted sub-content key by further encrypting the encrypted sub-content key using the session key Kses, (b) generates encrypted sub-content by encrypting the sub-content using the sub-content key, and then generates double-encrypted sub-content by further encrypting the encrypted sub-content using the session key Kses, and (c) generates an encrypted blacklist by encrypting the blacklist using the session key Kses. The contents supply apparatus 200 then transmits the double-encrypted sub-content key, the double-encrypted sub-content and the encrypted blacklist to the main player 300.

Next, the main player 300 receives the double-encrypted sub-content key, the double-encrypted sub-content and the encrypted blacklist. The main player 300 then (a) generates an encrypted sub-content key by decrypting the double-encrypted sub-content key using the session key Kses, (b) generates encrypted sub-content by decrypting the double-encrypted sub-content using the session key Kses, and (c) generates a blacklist by decrypting the encrypted blacklist using the session key Kses.

Next, the main player 300 writes the sub-content title ID, the encrypted sub-content key, the encrypted sub-content and the blacklist to the information storage unit 309. Furthermore, the main player 300 writes the sub-content title ID, the encrypted sub-content key, the encrypted sub-content and the blacklist to the memory card 600.

The main player 300 writes the encrypted sub-content to the memory card 600 in the following way.

When mutual device authentication is performed between the main player 300 and the memory card 600, the session key Kses is shared by the authentication unit 314 and the authentication unit 602, in the manner described earlier.

The main player 300 (a) generates a double-encrypted sub-content key by encrypting the sub-content using the session key Kses, (b) generates double-encrypted sub-content by encrypting the encrypted sub-content using the session key Kses, and (c) generates an encrypted blacklist by encrypting the blacklist using the session key Kses. Then the main player 300 transmits the sub-content title ID, the double-encrypted sub-content key, the double-encrypted sub-content and the encrypted blacklist to the memory card 600.

The memory card 600 receives the sub-content title ID, the double-encrypted sub-content key, the double-encrypted sub-content and the encrypted blacklist. The memory card 600 (a) generates an encrypted sub-content key by decrypting the double-encrypted sub-content key using the session key Kses, (b) generates encrypted sub-content by decrypting the double-encrypted sub-content using the session key Kses, and (c) generates a blacklist by decrypting the encrypted blacklist with use of the session key Kses. Next, the memory card 600 writes the sub-content title ID, the encrypted sub-content key, the encrypted sub-content and the blacklist to the information storage unit 603.

Furthermore, the main player 300 reads the encrypted sub-content from the memory card 600 in the following manner.

When mutual device authentication is performed between the main player 300 and the memory card 600, the session key Kses is shared by the authentication unit 314 and the authentication unit 602, in the manner described earlier.

The memory card 600 (a) generates a double-encrypted content key by encrypting the encrypted sub-content using the session key Kses, (b) generates double-encrypted sub-content by encrypting the encrypted sub-content using the session key Kses, and (c) generates an encrypted blacklist by encrypting the blacklist using the session key Kses. Next, the memory card 600 transmits the sub-content title ID, the double-encrypted sub-content key, the double-encrypted sub-content and the encrypted blacklist to the main player 300.

The main player 300 receives the sub-content title ID, the double-encrypted sub-content key, the double-encrypted sub-content and the encrypted blacklist. The main player 300 (a) generates an encrypted sub-content key by decrypting the double-encrypted sub-content key using the session key Kses, (b) generates encrypted sub-content by decrypting the double-encrypted sub-content using the session key Kses, and (c) generates a blacklist by decrypting the encrypted blacklist using the session key Kses.

(7) Although the sub-content is encrypted using the sub-content key in the embodiments, it is not mandatory for a sub-content key to exist.

In other words, the contents supply apparatus 200 may generate encrypted sub-content by encrypting the sub-content using the bind key, and transmit the generated encrypted sub-content to the main player 300.

The main player 300 receives the encrypted sub-content, and stores the encrypted content in the information storage unit 300 and the memory card 600. When playing back the encrypted sub-content, the main player 300 generates the sub-content by decrypting the encrypted content with use of the bind key, and plays back the generated sub-content.

(8) Although the recording medium on which the main content is recorded is described as being a ROM-type DVD or BD to which information writable only once, the main content may be recorded on another type of recording medium, an example of which is a CD-ROM. Furthermore, the recording medium on which the main content is recorded is not limited to being a ROM-type recording medium: the recording medium may be readable/writable recording medium.

(9) The sub-content is not limed to being a program for overlaying subtitle data of a movie as described in the preferred embodiment. The sub-content may have a structure of controlling the main content as a program such as a JAVA program. For example, the sub-data may be a program for replacing the audio of a movie or a broadcast program, or a program for editing playback scenes of main content. Furthermore, the sub-content may be independent content, such as content about the making of a movie. The screen may divided in two so that the main content and sub-content are played simultaneously, or the sub-content may be displayed in part of the screen displaying the main content.

Furthermore, original subtitles of the main content may be displayed simultaneously with sub-titles of another language, the sub-titles of the other language being the sub-content. For example, a structure in which Japanese subtitles are displayed as the main content simultaneously with English subtitles as the sub-content for the purpose of language study is possible. Furthermore, a plurality of sub-titles of varying difficulties of the English may be provided, and when subtitles corresponding to the user's level are selected from among the subtitles, the selected subtitles are displayed.

The following shows examples of sub-content.

### EXAMPLE 1

### Audio Replacement Program

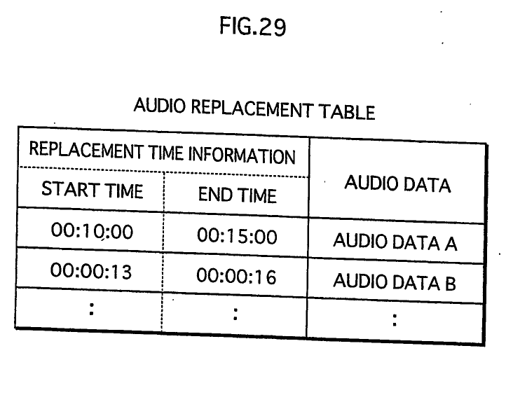

The audio replacement program is a program to playback sub-content audio data instead of the audio data of the main content, and has an audio replacement table shown in FIG. 29. The audio replacement table is composed of replacement time information and audio data. The audio data is the replacement audio data. The replacement time information includes a start time and an end time. The start time indicates a time at which replacement of corresponding audio data starts, and the end time indicates a time at which replacement of corresponding audio data ends.

When main content is played back, the audio replacement program counts the playback time, and when the playback time matches a start time, replaces the main content audio with the audio data corresponding to the starting time. Furthermore, when the playback time matches an end time, the audio playback program ends replacement of the main content audio data with the audio data corresponding to the end time.

### EXAMPLE 2

### Playback Scene Edit Program

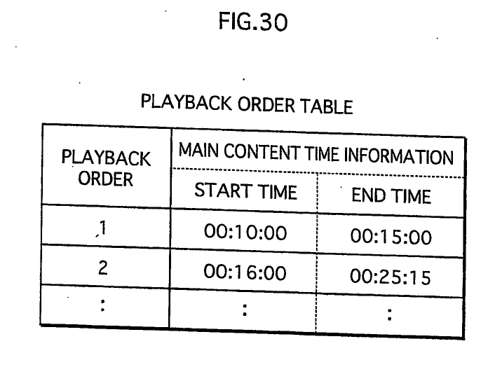

The playback scene edit program is a program for playing back the main content in an order that is different from the order recorded on a recording medium such as a BD, and has a playback order table shown in FIG. 30. The playback order table is composed of a playback order main content time information. The playback order indicates the order in which the main content is played back. The main content time information includes a start time and an end time. The playback order indicates playback of main content corresponding to a playback time between the corresponding start time and end time, in the corresponding position in the order.

The playback program edit program extracts the main content corresponding to the time between the start time and the end time corresponding to position 1 in the playback order, and plays that main content first. The playback edit program subsequently extracts the main content corresponding to the time between each set of start time and end time in the order shown by the playback order, and plays the main content in that order.

### EXAMPLE 3

### Link-Incorporated Subtitle Data Program

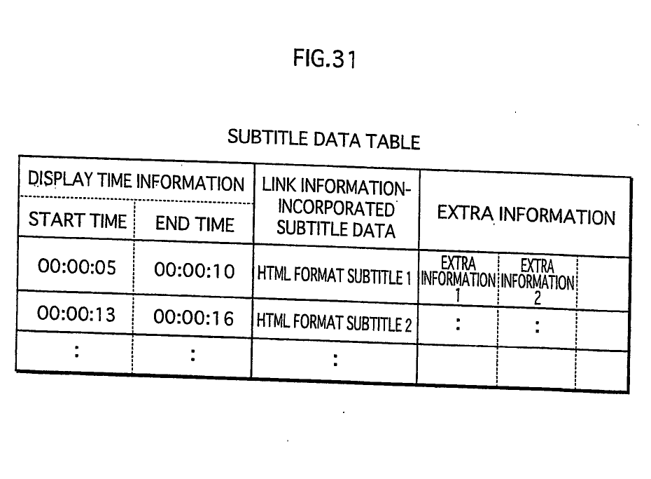

The link-incorporated subtitle data program displays subtitle data, which is in HTML format, on the screen, and when link information is selected, displays subtitle data of the link destination. The link-incorporated subtitle program has a subtitle data table shown in FIG. 31. The subtitle data table is composed of link information-incorporated subtitle data, and extra information. The display time includes a start time and an end time. The link-information incorporated subtitle data is subtitle data written in HTML format and relating to the main content, and includes link information. The extra information is extra information that is displayed when the link information of the link information-incorporated subtitle data is selected, and is, for example, the meaning of a word in a subtitle, an idiom, or the meaning of the subtitle in another language.

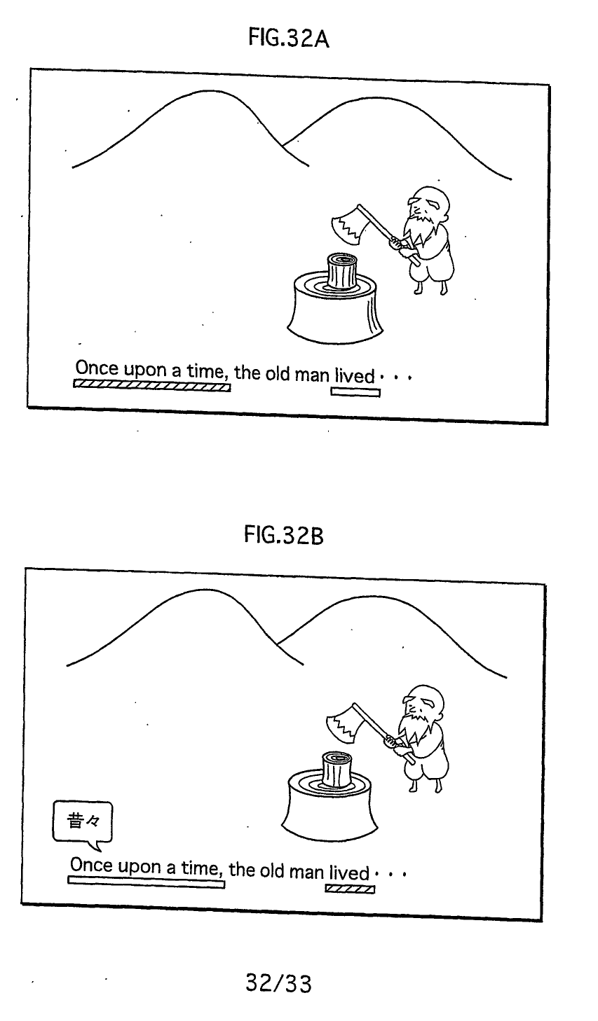

As one example, when the main content playback time corresponds to a time between the start time and the end time, the link-incorporated subtitle data program displays the corresponding subtitle with link information on the screen as shown in FIG. 32. Subtitle data that links to extra information is underlined. Here, if the user operates a remote control or the like and selects “Once upon a time,”, the Japanese “Mukashi mukashi” (“Once upon a time”) is displayed as extra information 1. Similarly, if “lived”, which corresponds to extra information 2, is selected, the Japanese “Sumu” (“live”) is displayed.

(10) Although the sub-content has been described as being used for replacement based on the playback time of the main content, another method is possible as long as the time information specifies the timing with which the sub-content is used for replacement, displayed, or the like.

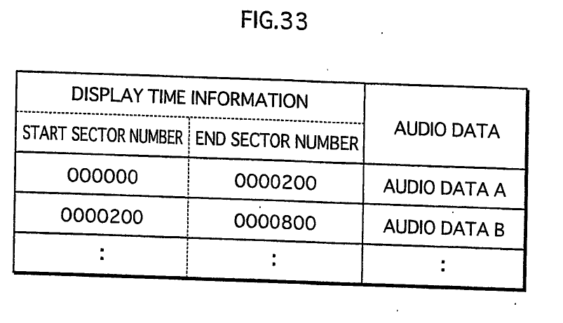

For example, as shown in FIG. 33, the start time and end time of the display time may be written as sector numbers on the disc, and the program may read which sector number the player is currently reading, and when the read sector number corresponds to that in the time information, perform corresponding processing such as replacement or overlay display. Note that instead of the sector number, the track number or the like may be used.

(11) Although the supplier of the sub-content is described in the embodiments as being one party, the supplier may be a plurality of parties.

(12) Although a signature is applied to the main content title ID and the sub-content in the second embodiment, the signature may instead be applied to the main content title ID and part of the sub-content.

(13) In the second embodiment, the sub-content is transmitted from the content provision apparatus 800 to the BD manufacturing apparatus 700 via the Internet 10. However, the content provision apparatus 800 and the BD manufacturing apparatus 700 may be connected by a special-purpose line, and the sub-content may be transmitted via that line. Furthermore, the contents supply apparatus 800 may record the sub-content on a recording medium, and the BD manufacturing apparatus 700 may read the sub-content from the recording medium.

(14) The main player may acquire the sub-content in the following manner.

The contents provision apparatus stores a plurality of sub-contents, and has a sub-content list that lists the title ID, the name and a summary of each sub-content. The contents supply apparatus transmits the sub-content list to the main player in response to a request from the main player.

The main player displays the sub-content list on the display unit. The user selects a desired sub-content from sub-content list, and inputs the selection. The main player transmits the title ID of the selected sub-content to the contents supply apparatus, and the contents supply apparatus transmits the sub-content indicated by the received sub-content title ID to the main player.

(15) Although the sub-contents supplier is billed in the second embodiment for payment with signature data and the public key corresponding to the authorized content attached thereto, billing may be performed without the public key certificate, in the following manner.

After acquiring the sub-content from the contents supply apparatus 800, the main player transmits the acquired sub-content title ID, sub-content, and signature data to the BD manufacturing apparatus 700.

The BD manufacturing apparatus 700 extracts the main content title ID from the received sub-content title ID, verifies the received signature data using the received sub-content and the extracted main content title ID, and if verification results in success, transmits authorization information to the main player.

On receiving an authorization signal, the main player is able to perform linked playback.

Furthermore, the BD manufacturing apparatus 700 is able to obtain information about how much a sub-content has been used from the sub-content title ID transmitted from the main player. Based on this information, the BD manufacturing apparatus 700 is able to determine the amount to bill the sub-contents supplier, and bill the sub-contents supplier.

Furthermore, when the sub-content title ID and the signature data are received from the main player, the BD manufacturing apparatus 700 is able to bill the user.

In addition, instead of signature data, the following structure may be used. The BD manufacturing apparatus encrypts the sub-content when permission for the sub-content is granted. The main player acquires the encrypted sub-content, and transmits the acquired encrypted sub-content to the BD manufacturing apparatus. The BD manufacturing apparatus receives the encrypted sub-content, verifies whether the received encrypted sub-content is authorized sub-content, and if so, transmits a decryption key to the main player. The main player receives the decryption key, decrypts the encrypted sub-content using the received decryption key, and plays the sub-content.

In this case, authorized sub-content can be played back even without the recording medium on which the main content is recorded.

(16) Although the public key is described as being sent with the sub-content in the second embodiment, the following structures are possible.

(a) The contents supply apparatus 800 transmits sub-content and signature data to the main player, and the main player transmits the received sub-content and signature data to the BD manufacturing apparatus 700.

The BD manufacturing apparatus 700 verifies the received signature data and sub-content, and if able to confirm that the sub-content is correct, authorized sub-content, transmits a public key certificate that includes a public key, to the main player.

The main player receives the public key certificate, extracts the public key, and verifies the signature data.

(b) The BD has the public key of the BD manufacturing apparatus recorded thereon in advance, and when granting permission for the sub-content, generates signature data using the recorded public key and the corresponding secret key. When verifying the signature data, the main player reads the public key from the BD, and verifies the signature.

Furthermore, in the above-described (a) and (b), the signature data may instead be encrypted sub-content, and the public key may instead be the decryption key.

(17) Although unauthorized sub-content is not able to be used in the embodiments, a structure in which a part of unauthorized sub-content is able to be used for a short time is possible. Furthermore, when the part is used, a message such as “unauthorized” may be displayed on the screen.

(18) Although the BD manufacturing apparatus 700 applies a digital signature to the main content title ID and the sub-content in the second embodiment, the sub-content supplier may generate the signature data.

The structure in this case is as follows.

(a) The BD manufacturing apparatus obtains a supplier public key certificate issued to the content supplier permitted by the BD manufacturing apparatus to create sub-content.

The BD manufacturing apparatus records the main content to the BD together with the supplier public key certificate. The BD to which the main content and the public key certificate have been recorded is distributed to a user.

The contents supplier holds a secret key issued by an authorization organization, and generates sub-content corresponding to main content. Furthermore, the contents supplier generates signature data by applying a digital signature to the main content title ID corresponding to the generated sub-content and the sub-content, using the secret key. The contents supplier encrypts the generated signature data and the sub-content as described in the second embodiment, and transmits the encrypted signature data and sub-content to the playback apparatus.

The playback apparatus receives and then records the sub-content.

Furthermore, when linked playback of sub-content and main content is performed, the playback apparatus reads a public key included in the public key certificate and the main content title ID from the BD on which the main content is recorded, and verifies the signature data with use of the sub-content, the title ID, and the public key. When the verification results in failure, the playback apparatus does not play back the sub-content. When the verification results in success, the playback apparatus reads the main content from the BD, and performs linked playback of the main content and the sub-content.

Note that it is sufficient for the data from which the signature is generated (hereinafter referred to as “signature target data”) to include information unique to the sub-content, and may be, for example, at least part of the sub-content, or a sub-content identifier.

(b) The BD manufacturing apparatus stores an identifier of a contents supplier permitted by the BD manufacturing apparatus to create sub-content, and a public key certificate issued to the contents supplier. The public key certificate includes a public key.

The BD manufacturing apparatus records the content supplier identifier on the BD on which the main content is recorded. Furthermore, the BD manufacturing apparatus records the public key certificate on another recording medium which is distributed to a user.

The contents supply apparatus generates signature data from signature target data that includes a contents supply apparatus identifier and the sub-content, and supplies the signature data to the playback apparatus together with the sub-content.

The playback apparatus stores the sub-content and the signature data. Furthermore, the user of the playback apparatus obtains another recording medium that has been distributed by the BD manufacturing apparatus.

When performing linked playback, the playback apparatus reads the supply apparatus identifier from the BD, reads the public key certificate from the other recording medium, and extracts the public key. The playback apparatus verifies the signature data with use of the read identifier and sub-content and with use of the extracted public key, and when verification is successful, performs linked playback of the sub-content and main content.

Note that it is sufficient for the signature target data from which the signature data is generated to include the identifier recorded on the BD. The identifier recorded on the BD may be a sub-content identifier, and in such a case, the sub-content identifier is included in the data from which the signature data is generated. Alternatively, information unique to the sub-content may be used instead of an identifier.

(c) Having received permission to create sub-content from the BD manufacturing apparatus, the contents supply apparatus obtains a main content title ID from the BD manufacturing apparatus, and transmits the public key certificate to the BD manufacturing apparatus.

Furthermore, the BD manufacturing apparatus receives the public key certificate of the contents supply apparatus to which permission has been given, and records the public key certificate to the BD together with the main content and the main content title ID.

The contents supply apparatus generates signature data by applying a digital signature to the acquired main content title ID, and distributes the generated signature data to the playback apparatus together with the sub-content.

When performing linked playback, the playback apparatus reads the main content title ID from the BD, extracts the public key from the public key certificate, and verifies the signature data with use of the public key. When verification results in success, the playback apparatus performs linked playback of the sub-content and the main content.

Note that rather than recording the contents supply apparatus public key certificate on the BD, the BD manufacturing apparatus may distribute the contents supply apparatus public key certificate recorded on another recording apparatus, or via a network.

Furthermore, instead of being the main content title ID, the signature target data may be at least part of the main content. It is sufficient that the signature target data is information unique to the main content.

(d) Although signature data is described as being generated in (a) to (c), instead of generating signature data, signature target data may be encrypted, thereby generating encrypted data.

(e) In (a) to (c), the BD manufacturing apparatus may verify the signature data as described in (15). In this case, it is unnecessary for the BD manufacturing apparatus to distribute a contents supply apparatus public key certificate. Instead, it is sufficient for the BD manufacturing apparatus to hold, not distribute, the contents supply apparatus public key certificate.

Having obtained the sub-content and the signature data from the contents supply apparatus, the playback apparatus transmits the sub-content and the signature data to the BD manufacturing apparatus.

The BD manufacturing apparatus extracts the public key from the public key certificate of the contents supply apparatus that has been given permission to manufacture sub-content, and performs verification. When successful, the BD manufacturing apparatus transmits an authorization signal to the playback apparatus. On receiving the authorization signal, the playback apparatus plays back the sub-content.

Note that BD manufacturing apparatus may transmit a public key certificate to the playback apparatus when verification is successful, instead of the authorization signal. Furthermore, when the signature data is encrypted data that has been generated by encrypting signature target data, the BD manufacturing apparatus may transmit a decryption key.

(19) The present invention may be methods shown by the above. Furthermore, the methods may be a computer program realized by a computer, and may be a digital signal of the computer program.

Furthermore, the present invention may be a computer-readable recording medium apparatus such as a flexible disk, a hard disk, a CD-ROM, an MO, a DVD, a DVD-ROM, a DVD RAM, a BD (Blu-Ray Disc), or a semiconductor memory, that stores the computer program or the digital signal. Furthermore, the present invention may be the computer program or the digital signal recorded on any of the aforementioned recording media.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal via a network or the like, the program or the digital signal may be executed by another independent computer system.

(20) The present invention may be any combination of the above-described embodiments and modifications.

4. Summary

As has been described, the present invention is a contents distribution system for distributing second content relating to first content that is recorded on a recording medium, including: a second-contents supply apparatus operable to output signature data and the second content, the signature data having been generated based on content information of at least one of the first content and the second content, with use of first key information; a key output apparatus operable to output second key information corresponding to the first key information; a verification apparatus operable to verify the signature data with use of the second key information; and a playback apparatus operable to play back the second content when the verification is successful.

According to the stated structure, the signature data output by the second contents supply apparatus is verified with use of second key information output by another key output apparatus. Therefore, without signature data generated using first key information corresponding to second key information used in verification, content is not played back. In other words, even if illegal content is supplied, it is not played back. This enables content distributed by a legal contents supply apparatus to be played back, and prevents playback of content supplied by an illegal supply apparatus.

Furthermore, the present invention is a signature apparatus including: an acquisition unit operable to acquire, from a supply apparatus that supplies second content relating to first content that is distributed recorded on a recording medium, at least part of the second content; a signature unit operable to generate signature information based on content information that includes the at least part of the second content, with use of first key information; and an output unit operable to output the generated signature data to the supply apparatus, and output second key information that corresponds to the first key information and that is used for verifying the signature data.

According to the stated structure, the signature apparatus generates signature data for the content generated by the supply apparatus. Therefore, even if the supply apparatus supplies second content, the second content is not played back unless the signature apparatus generates signature data. Consequently, illegal content that is not permitted to be supplied is prevented from being used. Here, the signature apparatus may further include: a billing unit including: an acquisition sub-unit operable to acquire, from the supply apparatus, reception information indicating that the signature data and the second key information have been received; and a billing sub-unit operable to perform billing processing with respect to the supply apparatus in order to bill for authorization of the second content, when the acquisition sub-unit has acquired the reception information.

According to the stated structure, billing can be performed for payment for generating signature data for second content of which supply has been permitted.

Here, the signature apparatus may further include: a retaining unit operable to retain the first key information and the second key information; a verification unit operable to receive, from a playback apparatus for playing back the second content, other signature data acquired by the playback apparatus from the supply apparatus, and verify the received other signature data with use of the second key information; and a transmission unit operable to transmit, to the playback apparatus, a permission signal indicating permission to play back the second content, when the verification is successful, wherein the output unit suppresses output of the second key information.

According to the stated structure, the signature apparatus performs verification of the signature data. Therefore, it can be confirmed whether or not content obtained by the playback apparatus is permitted content. Furthermore, the signature apparatus obtains and verifies signature data that was supplied to the playback apparatus, and therefore the signature apparatus is able to grasp the amount of content used.

Here, the signature unit may generate the signature data by encrypting the content information with use of the first key information, and outputs the generated signature data to the supply apparatus, the verification unit may verify whether or not the other signature data received from the playback apparatus has been encrypted by the signature unit, and the transmission unit may transmit the second key information as a decryption key when the verification is successful.

According to the stated structure, in the case of content that is permitted to be supplied, since a decryption key is transmitted to the playback apparatus, the playback apparatus is unable to playback content unless the content is proven to be permitted content. Therefore, playback of illegal content can be prevented.

Here, the signature apparatus may further include: a billing unit operable to acquire, from the playback apparatus, a reception signal indicating that the permission signal has been received, and perform billing processing with respect to the supply apparatus to bill for use of the second content.

According to the stated structure, the playback apparatus is billed after provision of second content, and therefore billing can be performed according to the usage amount of the second content. Furthermore, the present invention is a contents supply apparatus for supplying second content relating to first content that is distributed recorded on a recording medium, including: an acquisition unit operable to acquire the second content; and an output unit operable to output supply information that includes signature data and second content to a playback apparatus, the signature data having been generated based on content information relating to at least one of the first content and the second content with use of first key information that corresponds to second key information output by a distribution apparatus that distributes the first content.

According to the stated structure, a distribution apparatus distributes second key information that corresponds to first key information used in generating signature data, and therefore, even if the distribution apparatus distributes content for which distribution permission has not been given, the content will not be played back. Consequently, supply of illegal content can be prevented.

Here, the contents supply apparatus may further include: a transmission unit operable to transmit second unique information that is unique to the second content, to the distribution apparatus, wherein the acquisition unit acquires signature data from the distribution apparatus, the signature data having been generated based on content information that contains the second unique information.

According to the stated structure, signature data is generated by the distribution apparatus for the second unique information that is unique to the second content generated by the supply apparatus. Therefore, second content that is permitted by the distribution apparatus and for which signature data is generated is played back, and content that is not permitted is not played back.

Here, the acquisition unit may acquire the signature data that has been generated by the distribution apparatus by encrypting the content information, and the output unit may output the signature data as the supply data.

According to the stated structure, the signature data is encrypted by the distribution apparatus, and therefore not encrypted, and consequently not played back, unless permitted by the distribution apparatus. Accordingly, the supply apparatus is able to supply only permitted content, and therefore playback of illegal content can be prevented.

Here, the contents supply apparatus may further include: a signature unit operable to generate the signature data; and a transmission unit operable to transmit the second key information to the distribution apparatus, wherein the second key information is distributed from the distribution apparatus to a playback apparatus by one of the recording medium, another recording medium, and a network.

According to the stated structure, the supply apparatus outputs signature data generated by the supply apparatus, together with the second content, but the second key information for verifying the signature data is output by the distribution apparatus. Therefore, if distribution of the second content is permitted but the second key information is not distributed by the distribution apparatus, the second content is not playedback. Accordingly, content permitted by the distribution apparatus is played back, but content that is not permitted by the distribution apparatus is not played back.

Here, the transmission unit may transmit, to the distribution apparatus, one of second unique information unique to the second content and an identifier that identifies the supply apparatus, the signature unit may generate the signature data by applying a digital signature to the content information that includes the one of the second unique information and the identifier, and the content information may be distributed to the playback apparatus by the distribution apparatus.

According to the stated structure, the supply apparatus generates signature data for either the second unique information that is unique to second content generated by the supply apparatus, or the supply apparatus identifier, but the second unique information or the identifier used in signature verification is output by the distribution apparatus. Therefore, content that is not permitted by the distribution apparatus is not played back.

Here, the acquisition unit may acquire, from the distribution apparatus, first unique information that is unique to the first content, and the signature unit may generate the signature data by applying a digital signature to the content information that includes the acquired first unique information.

According to the stated structure, since the supply apparatus generates signature data for first unique information acquired from the distribution apparatus, correct signature information cannot be generated unless the first unique information is acquired with permission for distribution of the content from the distribution apparatus. Consequently, playback of content not permitted by the distribution apparatus can be prevented.

Furthermore, the present invention is a playback apparatus for playing back second content relating to first content that is distributed recorded on a recording medium, including: an acquisition unit operable to acquire the second content; and a playback unit operable to playback the second content when verification of signature data is successful, the signature data having been generated based on content information relating to at least one of the first and second content and that has been output by a supply apparatus that supplies the second content, and the verification having been performed with use of second key information output by a distribution apparatus that distributes the first content.

According to the stated structure, the second content is played back when verification results in success, and therefore content that does not have correct signature data that can be verified with second key information distributed by the distribution apparatus is not played back. This means that second content relating to first content is not played back without permission from the distribution apparatus. Therefore, use of illegal content is prevented.

Here, the acquisition unit may acquire the signature data and the second key information, and the playback apparatus may further include: a verification unit operable to verify the signature data with use of the second key information.

According to the stated structure, the playback apparatus is able to perform verification.

Here, the first key information and the second key information may be key information issued with respect to the distribution apparatus, the signature data may be generated by the distribution apparatus by applying a digital signature to content generated by the supply apparatus, and the acquisition unit may acquire the signature data from the supply apparatus and verifies the signature data.

According to the stated structure, signature data generated using the distribution apparatus secret key and acquired from the supply apparatus is used to verify the public key acquired from the distribution apparatus. Therefore, content that is not permitted by the distribution apparatus is not played back. This prevents playback of content that is illegal and not permitted by the distribution apparatus.

Here, the first key information and the second key information may be key information issued with respect to the supply apparatus, the signature data may be generated by the supply apparatus by applying a digital signature to the content information that is about content generated by the supply apparatus, and the acquisition unit may acquire the signature data from the supply apparatus and acquires the second key information from the distribution apparatus.

According to the stated structure, since signature data generated by the supply apparatus is verified using second key information output by the distribution apparatus, content permitted by the distribution apparatus is played back, and content not permitted by the distribution apparatus is not played back.

Here, the acquisition unit may acquire, from the recording medium on which the first content is recorded, key data recorded by the distribution apparatus, and derives the second key information based on the key data.

According to the stated structure, key data for extracting the second key information is recorded in advance by the distribution apparatus, and the second key data cannot be extracted without the recording medium. Therefore, possession of the recording medium can be made to be a condition for playing back the second content.

Here, the signature data may be generated with respect to the content information which further includes first unique information that is unique to the first content, the acquisition unit may acquire the first unique information from the recording medium on which the first content is recorded, and the verification unit may verify the signature data further using the first unique information.

According to the stated structure, the information from which a signature is generated is written in advance to a recording medium by the distribution apparatus. Therefore, possession of the recording medium can be made to be a condition for playing back the second content.

Here, the acquisition unit may obtain supply information from the supply apparatus, the supply information including the second content and the signature data, and the playback unit may include: a transmission sub-unit operable to transmit the supply information to the distribution apparatus; a reception sub-unit operable to receive a verification result from the distribution apparatus; and a playback sub-unit operable to play back the second content when the received verification result indicates success.

According to the stated structure, since the distribution apparatus performs verification, it is unnecessary for the playback apparatus to perform verification, and the amount of processing by the playback apparatus is reduced.

Here, the acquisition unit may acquire the signature data as the supply data, the signature data having been generated by encrypting the second content with use of the first key information, when verification by the distribution apparatus is successful, the reception sub-unit may receive the second information from the distribution apparatus as a decryption key, and the playback sub-unit may generate the second content by decrypting the signature data with use of the second key information.

According to the stated structure, the playback apparatus receives the second key information as the decryption key when verification results in success. Therefore, when verification results in failure, in other words, when the second content is illegal, the second content cannot be decrypted, and consequently, cannot be played back. This prevents usage of illegal content.

Furthermore, the present invention is a distribution apparatus for distributing permission information indicating permission to supply second content that relates to first content that is distributed recorded on a recording medium, including: an acquisition unit operable to acquire second key information from a supply apparatus that is permitted to supply the second content, the second key information corresponding to first key information used in generation of signature data that is supplied together with the second content; and a recording unit operable to record the second key information that is to be used by a playback apparatus to verify the signature data, to the recording medium on which the first content is recorded.

According to the stated structure, since second key information of the supply apparatus that is permitted to supply content is recorded in advance on the recording medium, only content of a supply apparatus that has been permitted in advance by the distribution apparatus to supply content can be played back. The prevents use of illegal content.

### INDUSTRIAL APPLICABILITY

The described digital work protection system and content distribution system can be used for business purposes, in other words, repeatedly and continuously, in a software industry in which digital digitized content that is a protected work such as music, a movie, or software such as a computer program, is provided. Furthermore, the software writing apparatus, information processing apparatus, server apparatus and memory card of the present invention can be produced by a manufacturer of electronic products, and sold.

1. A contents distribution system for distributing second content relating to first content that is recorded on a recording medium, comprising:
a second-contents supply apparatus operable to output signature data and the second content, the signature data having been generated based on content information of at least one of the first content and the second content, with use of first key information;
a key output apparatus operable to output second key information corresponding to the first key information;
a verification apparatus operable to verify the signature data with use of the second key information; and
a playback apparatus operable to play back the second content when the verification is successful.

2. A signature apparatus comprising:
an acquisition unit operable to acquire, from a supply apparatus that supplies second content relating to first content that is distributed recorded on a recording medium, at least part of the second content;
a signature unit operable to generate signature information based on content information that includes the at least part of the second content, with use of first key information; and
an output unit operable to output the generated signature data to the supply apparatus, and output second key information that corresponds to the first key information and that is used for verifying the signature data.

3. The signature apparatus of claim 2, further comprising:
a billing unit including:
an acquisition sub-unit operable to acquire, from the supply apparatus, reception information indicating that the signature data and the second key information have been received; and
a billing sub-unit operable to perform billing processing with respect to the supply apparatus in order to bill for authorization of the second content, when the acquisition sub-unit has acquired the reception information.

4. The signature apparatus of claim 2, further comprising:
a retaining unit operable to retain the first key information and the second key information;
a verification unit operable to receive, from a playback apparatus for playing back the second content, other signature data acquired by the playback apparatus from the supply apparatus, and verify the received other signature data with use of the second key information; and
a transmission unit operable to transmit, to the playback apparatus, a permission signal indicating permission to play back the second content, when the verification is successful,
wherein the output unit suppresses output of the second key information.

5. The signature apparatus of claim 4, wherein
the signature unit generates the signature data by encrypting the content information with use of the first key information, and outputs the generated signature data to the supply apparatus,
the verification unit verifies whether or not the other signature data received from the playback apparatus has been encrypted by the signature unit, and
the transmission unit transmits the second key information as a decryption key when the verification is successful.

6. The signature apparatus of claim 4, further comprising:
a billing unit operable to acquire, from the playback apparatus, a reception signal indicating that the permission signal has been received, and perform billing processing with respect to the supply apparatus to bill for use of the second content.

7. A contents supply apparatus for supplying second content relating to first content that is distributed recorded on a recording medium, comprising:
an acquisition unit operable to acquire the second content; and
an output unit operable to output supply information that includes signature data and second content to a playback apparatus, the signature data having been generated based on content information relating to at least one of the first content and the second content with use of first key information that corresponds to second key information output by a distribution apparatus that distributes the first content.

8. The contents supply apparatus of claim 7, further comprising:
a transmission unit operable to transmit second unique information that is unique to the second content, to the distribution apparatus,
wherein the acquisition unit acquires signature data from the distribution apparatus, the signature data having been generated based on content information that contains the second unique information.

9. The contents supply apparatus of claim 8, wherein
the acquisition unit further acquires the second key information from the distribution apparatus, and
the output unit further outputs the second key information.

10. The supply apparatus of claim 8, wherein
the acquisition unit acquires the signature data that has been generated by the distribution apparatus by encrypting the content information, and
the output unit outputs the signature data as the supply data.

11. The contents supply apparatus of claim 7, further comprising:
a signature unit operable to generate the signature data; and
a transmission unit operable to transmit the second key information to the distribution apparatus,
wherein the second key information is distributed from the distribution apparatus to a playback apparatus by one of the recording medium, another recording medium, and a network.

12. The contents supply apparatus of claim 11, wherein
the transmission unit transmits, to the distribution apparatus, one of second unique information unique to the second content and an identifier that identifies the supply apparatus,
the signature unit generates the signature data by applying a digital signature to the content information that includes the one of the second unique information and the identifier, and
the content information is distributed to the playback apparatus by the distribution apparatus.

13. The contents supply apparatus of claim 11, wherein
the acquisition unit acquires, from the distribution apparatus, first unique information that is unique to the first content, and
the signature unit generates the signature data by applying a digital signature to the content information that includes the acquired first unique information.

14. A playback apparatus for playing back second content relating to first content that is distributed recorded on a recording medium, comprising:
an acquisition unit operable to acquire the second content; and
a playback unit operable to play back the second content when verification of signature data is successful, the signature data having been generated based on content information relating to at least one of the first and second content and that has been output by a supply apparatus that supplies the second content, and the verification having been performed with use of second key information output by a distribution apparatus that distributes the first content.

15. The playback apparatus of claim 14, wherein
the acquisition unit acquires the signature data and the second key information, and
the playback apparatus further comprises:
a verification unit operable to verify the signature data with use of the second key information.

16. The playback apparatus of claim 15, wherein
the first key information and the second key information are key information issued with respect to the distribution apparatus,
the signature data is generated by the distribution apparatus by applying a digital signature to content generated by the supply apparatus, and
the acquisition unit acquires the signature data from the supply apparatus and verifies the signature data.

17. The playback apparatus of claim 15, wherein
the first key information and the second key information are key information issued with respect to the supply apparatus,
the signature data is generated by the supply apparatus by applying a digital signature to the content information that is about content generated by the supply apparatus, and
the acquisition unit acquires the signature data from the supply apparatus and acquires the second key information from the distribution apparatus.

18. The playback apparatus of claim 17, wherein
the acquisition unit acquires, from the recording medium on which the first content is recorded, key data recorded by the distribution apparatus, and derives the second key information based on the key data.

19. The playback apparatus of claim 15, wherein
the signature data is generated with respect to the content information which further includes first unique information that is unique to the first content,
the acquisition unit acquires the first unique information from the recording medium on which the first content is recorded, and
the verification unit verifies the signature data further using the first unique information.

20. The playback apparatus of claim 14, wherein
the acquisition unit obtains supply information from the supply apparatus, the supply information including the second content and the signature data, and
the playback unit includes:
a transmission sub-unit operable to transmit the supply information to the distribution apparatus;
a reception sub-unit operable to receive a verification result from the distribution apparatus; and
a playback sub-unit operable to play back the second content when the received verification result indicates success.

21. The playback apparatus of claim 20, wherein
the acquisition unit acquires the signature data as the supply data, the signature data having been generated by encrypting the second content with use of the first key information,
when verification by the distribution apparatus is successful, the reception sub-unit receives the second information from the distribution apparatus as a decryption key, and
the playback sub-unit generates the second content by decrypting the signature data with use of the second key information.

22. A distribution apparatus for distributing permission information indicating permission to supply second content that relates to first content that is distributed recorded on a recording medium, comprising:
an acquisition unit operable to acquire second key information from a supply apparatus that is permitted to supply the second content, the second key information corresponding to first key information used in generation of signature data that is supplied together with the second content; and
a recording unit operable to record the second key information that is to be used by a playback apparatus to verify the signature data, to the recording medium on which the first content is recorded.

23. The distribution apparatus of claim 22, wherein
the acquisition unit acquires one of an identifier of the second content and an identifier of the supply apparatus, and
the recording unit records the acquired identifier to the recording medium, and instead of recording the second key information to the recording medium, distributes the second key information to the playback apparatus by recording the second key information on another recording medium or via a network.

24. A playback program used in a playback apparatus for playing back second content relating to first content that is distributed recorded on a recording medium, the playback program comprising:
an acquisition step of acquiring the second content; and
a playback unit step of playing back the second content when verification of signature data is successful, the signature data having been generated based on content information relating to at least one of the first and second content and that has been output by a supply apparatus that supplies the second content, and the verification having been performed with use of second key information output by a distribution apparatus that distributes the first content.

25. A program recording medium having stored thereon a playback program used in a playback apparatus for playing back second content relating to first content that is distributed recorded on a recording medium, the playback program comprising:
a playback unit step of playing back the second content when verification of signature data is successful, the signature data having been generated based on content information relating to at least one of the first and second content and that has been output by a supply apparatus that supplies the second content, and the verification having been performed with use of second key information output by a distribution apparatus that distributes the first content.
